(19) United States
(12) Patent Application Publication
(10) Pub. No.: US 2025/0100606 A1
(43) Pub. Date: Mar. 27, 2025

(54) OUTDOOR CAMPING DEVICE, CAMPING CART, AND FOLDABLE CART FRAME

(71) Applicant: Hangzhou Oneforest Technologies Co,. Ltd, Hangzhou City (CN)

(72) Inventors: Zhou FANG, Hangzhou City (CN); Enwei ZHANG, Hangzhou City (CN); Yuanzhi ZHU, Hangzhou City (CN); Chonglong SU, Hangzhou City (CN)

(21) Appl. No.: 18/977,056

(22) Filed: Dec. 11, 2024

Related U.S. Application Data
(63) Continuation-in-part of application No. 18/870,044, filed on Jan. 1, 0001.

(30) Foreign Application Priority Data
Dec. 16, 2022 (CN) 202211623679.0
Aug. 10, 2023 (CN) 202322140848.1
Aug. 10, 2023 (CN) 202322141786.6
Aug. 10, 2023 (CN) 202322142097.7
Aug. 10, 2023 (CN) 202322142383.3
Dec. 12, 2023 (CN) 202323384572.8
Jan. 19, 2024 (CN) 202420142778.8

(51) Int. Cl. B62B 3/02; B62B 5/00

(52) U.S. Cl. CPC B62B 3/02; B62B 5/0013; B62B 2205/06

(57) ABSTRACT

Provided in the present application are an outdoor camping device, a camping cart, and a foldable cart frame. A foldable camping cart includes a first frame and a second frame, the first frame and the second frame being folded and unfolded by means of a folding mechanism, the folding mechanism being configured at a bottom of the camping cart to be adapted for load-bearing, where the folding mechanism includes: an upper folding member, which is operable to be folded upwards; a lower folding member, which is foldable upwards and is configured to support the upper folding member in a preset position in an unfolded state; and a linkage component configured to connect the upper folding member and the lower folding member to the first frame and to hold the upper folding member in the preset position in the unfolded state.

### TECHNICAL FIELD

The present application relates to the field of carts, and in particular to an outdoor camping device, a camping cart, and a foldable cart frame.

### BACKGROUND

With the increasing abundance of life, outdoor camping is becoming more and more popular. As more and more people go camping, types of camping supplies are increasing, and people carry more items when they go camping. Therefore, carrying of items has become one of the difficulties. Since most camping trips are taken in private vehicles with limited storage space, loading and unloading of items is one of the main problems. It is necessary for large items like camping carts to be foldable. However, existing camping carts have technical issues such as complicated folding and inconvenient use.

For example, the Chinese utility model patent application No. 202121938856.5 entitled “an outdoor foldable camping cart” discloses an outdoor foldable camping cart including a pull rod apparatus, a cart frame, and a universal wheel. The cart frame includes a supporting vertical rod, a left-right foldable side rail, a front-rear foldable side rail, a bottom I-shaped component, a first connecting member, a second connecting member, and a third connecting member. The pull rod apparatus is connected to the supporting vertical rod, and the universal wheel is disposed at the bottom of the supporting vertical rod. The first connecting member, the second connecting member, and the third connecting member are sequentially disposed around upper, middle, and lower portions of the supporting vertical rod. Upper and lower ends of the left-right foldable side rail and upper and lower ends of the front-rear foldable side rail are hingedly connected to the first connecting member and the second connecting member. Ends of the bottom I-shaped component are hingedly connected to the third connecting member. This utility model has a simple structure, easy assembly and disassembly, a simple frame shape, and a relatively light overall weight. The second connecting member slides on the vertical rod to drive the cart body to fold or unfold, making it easy to store and transport, and ensuring good stability of the cart body in any state. This camping cart is folded in a gathered manner, which cannot adjust the body size of the camping cart according to usage conditions, such as full opening, or half opening. Moreover, being folded in a gathered manner cannot meet the needs of different usage scenarios.

For another example, the Chinese utility model patent No. CN217553949U discloses a foldable cart, in which the foldable cart has a relatively complicated structure, has many movable hinge points, requires a high matching accuracy, and has a large volume after folded, occupying much space. To simplify the structure of the foldable cart and make the folding of the foldable cart more convenient, the Chinese utility model patent No. CN210083272U discloses a novel foldable cart, which includes a front bracket, a rear bracket, and an underframe assembly which can be folded upwards or unfolded downwards, where the underframe assembly includes a front underframe and a rear underframe. The front bracket and the rear bracket are respectively provided with wheels at bottom ends thereof. A front end of the front underframe is hingedly connected to the front bracket, a rear end of the rear underframe is hingedly connected to the rear bracket, and a rear end of the front underframe is movably connected to a front end of the rear underframe. The foldable cart further includes a support assembly provided below the underframe assembly to support the underframe assembly. The support assembly includes a front support rod and a rear support rod, where one end of the front support rod is rotatably connected to the front bracket, the other end of the front support rod is rotatably connected to one end of the rear support rod, and the other end of the rear support rod is rotatably connected to the rear bracket. As the underframe assembly is folded upwards, the support assembly is folded along one transverse side, and as the underframe assembly is unfolded downwards, the support assembly is unfolded along the other transverse side. However, the foldable cart in the above patent still has the following problems during use. Firstly, the folding movements of the support assembly and the underframe assembly are independent of each other, and the folding directions of the support assembly and the underframe assembly are different from each other, one is folded vertically and the other is folded transversely, such that asynchronous folding of the support assembly and the underframe assembly may occur during the folding process, and a user needs to apply forces to the support assembly and the underframe assembly respectively to fold the foldable cart, which is inconvenient to use. Secondly, the support assembly only supports one side of the underframe assembly, which may cause different degrees of deformation on both sides of the underframe assembly, and is likely to lead to serious deformation on one side of the underframe assembly, thus affecting the service life of the foldable cart.

### SUMMARY

The technical problem to be solved by the present application is to overcome the aforementioned deficiencies in the related art, and to provide an outdoor camping device, a camping cart, and a foldable cart frame.

To achieve the above objectives, the present application adopts the following technical solutions.

In a first aspect, the present application provides a foldable cart frame, applied to a portable carrying cart, the foldable cart frame including a first frame and a second frame arranged in a length direction, where the foldable cart frame further includes a middle frame arranged between the first frame and the second frame, where the first frame and the middle frame are connected by a first folding component to enable the first frame to be folded and unfolded with respect to the middle frame, and a first storage cavity is formed between the first frame and the middle frame when unfolded; and where the second frame and the middle frame are connected by a second folding component to enable the second frame to be folded and unfolded with respect to the middle frame, and a second storage cavity is formed between the second frame and the middle frame when unfolded.

The above technical solution can be further improved as follows.

In a preferred embodiment, the first folding component and the second folding component are foldable and unfoldable relatively independently of each other. The first storage cavity and the second storage cavity are foldable and unfoldable independently of each other. Further, the first folding component is adapted to fold only inward of the first storage cavity, and the second folding component is adapted to fold only inward of the second storage cavity.

Further, the first folding component includes two lateral hinges arranged opposite each other in a width direction, each of the lateral hinges including a first hinge plate and a second hinge plate that are pivotally connected to each other, where the first hinge plate is pivotally connected to the first frame, and the second hinge plate is pivotally connected to the middle frame. Preferably, the lateral hinge is configured in an X-shape.

Further, the first folding component further includes a bottom hinge extending in the length direction, the bottom hinge including a third hinge plate and a fourth hinge plate that are pivotally connected to each other, where the third hinge plate is pivotally connected to the first frame, and the fourth hinge plate is pivotally connected to the middle frame. Preferably, each of the third hinge plate and the fourth hinge plate includes a plurality of support strips for supporting items.

In a preferred embodiment, a folding linkage mechanism is arranged between the lateral hinge and the bottom hinge to enable stable synchronous folding or unfolding of the lateral hinge and the bottom hinge.

Further, the folding linkage mechanism includes: a first connecting link pivotally connected to the lateral hinge; a second connecting link pivotally connected to the bottom hinge; and a third connecting link pivotally connected to the first connecting link and the second connecting link between the first connecting link and the second connecting link, so as to transmit movement between the first connecting link and the second connecting link.

Further, the first connecting link is configured to rotate around a first pivot shaft, and the second connecting link is configured to rotate around a second pivot shaft, the first pivot shaft and the second pivot shaft being perpendicular to each other, where the first pivot shaft is adapted to connect the first connecting link and the third connecting link, and the second pivot shaft is adapted to connect the second connecting link and the third connecting link.

Preferably, the folding linkage mechanism is arranged correspondingly on the first frame, the middle frame, and the second frame.

Further, the first folding component and the second folding component are arranged symmetrically with respect to the middle frame.

In a preferred embodiment, the middle frame is configured in a U-shape, and includes two lateral columns arranged opposite each other in a width direction, and a bottom beam for connecting the two lateral columns.

Further, at least one locking apparatus is provided on the middle frame, and is configured to lock the first frame and/or the second frame to the middle frame.

Further, the locking apparatus includes: a first locking portion for locking the first frame to keep the first folding component in a folded state; and a second locking portion for locking the second frame to keep the second folding component in a folded state.

In some embodiments, the locking apparatus is configured as two sets of locking apparatuses arranged opposite each other in a width direction of the cart frame, where each set of locking apparatuses includes two locking apparatuses arranged on upper and lower sides of the middle frame, respectively.

In other embodiments, the locking apparatus is configured as two sets of locking apparatuses arranged opposite each other in a width direction of the cart frame, where each set of locking apparatuses includes two locking apparatuses arranged on left and right sides of the middle frame, respectively.

In a second aspect, the present application further provides a camping cart including a cart frame, where the cart frame is the foldable cart frame as described above in the first aspect.

In an embodiment, a first housing is fixedly attached to the first frame, and a second housing is fixedly attached to the second frame; and when the first folding component and the second folding component are both in a folded state, an accommodating cavity is formed between the first housing and the second housing to accommodate the cart frame. Further, the first housing has a first cavity recessed towards a side away from the middle frame, and the second housing has a second cavity recessed towards the side away from the middle frame, a combination of the first cavity and the second cavity forming the accommodating cavity. Preferably, the camping cart is constructed in a shape of a suitcase or toolbox.

In a third aspect, the present application further provides an outdoor camping device including a camping cart, where the camping cart is the camping cart as described above in the second aspect.

In an embodiment, the camping cart has a support apparatus on a top thereof, the support apparatus including at least one pair of support bars arranged opposite each other in a width direction of the camping cart, the support bars extending in a length direction of the camping cart, where the pair of support bars are configured such that the support bars are adapted to support a functional unit across the storage cavity in the width direction and to limit movement of the functional unit in the width direction, the functional unit being a table board, stove, or basin.

Further, the support bars are detachably attached to the top of the camping cart, and a corresponding one of the support bars is separated from the camping cart in a folded state.

Further, the camping cart is provided with a plurality of end corner members at end corners thereof, the end corner members having positioning portions extending in the length direction, and the support bars being detachably attached to the positioning portions.

In another embodiment, the camping cart has a weather shelter detachably incorporated on a top thereof, the weather shelter including: a canopy covering the top of the camping cart; and a skeleton system configured to securely support the canopy, where the skeleton system includes: a plurality of support columns arranged in a vertical direction; a truss component configured to form connections between the plurality of support columns and to separate the plurality of support columns from each other; and a pole component attached to the truss component to support the canopy in a deployed state, where the truss component includes: connecting seats attached to a top of the support columns; and a connecting rod adapted to connect two of the connecting seats, and where the pole component includes a plurality of poles attached to the connecting seats.

Further, the truss component includes two connecting rods crossing each other, each of which is connected between corresponding two of the connecting seats arranged opposite each other.

Further, the pole component includes an upper pole and a lower pole crossing each other, and correspondingly, the connecting seat has an upper hole for the upper pole to pass through and a lower hole for the lower pole to pass through.

Further, the camping cart is provided with a plurality of end corner members at end corners thereof, which have expansion interfaces for insertion of the support columns.

With the above technical solutions, the present application has the following beneficial effects.

Firstly, the foldable cart frame according to the present application has a three-frame and two-cavity structure, which includes a first frame, a middle frame, and a second frame, with an independently usable first storage cavity formed between the first frame and the middle frame, and an independently usable second storage cavity formed between the middle frame and the second frame. The first and second frames can be folded and unfolded with respect to the middle frame, such that the present application can be adjusted to a two-cavity state, a single-cavity state, or a fully-folded state as needed, which is convenient to use and easy to store.

Secondly, the camping cart according to the present application is equipped with a plurality of end corner members at end corners thereof, which have multiple expansion portions, suitable for mounting support bars to support at least one of functional appliances such as table boards, stoves, or basins, facilitating users' outdoor cooking needs. Meanwhile, the end corner members are suitable for mounting a weather shelter, such as a canopy, for shading, which enhances the user experience.

Thirdly, the present application has the technical effects of unique appearance, novel design of folding structure, easy assembly and disassembly, and relatively light overall weight.

In a fourth aspect, the present application further provides a foldable camping cart, which has a folding mechanism configured at the bottom, and adopts a folding structure in which an upper folding member and a lower folding member are stacked, so as to improve the load-bearing effect of the camping cart. Meanwhile, the upper folding member and the lower folding member are connected by a linkage component, such that the upper folding member, when folded, can drive the lower folding member to rotate, which enables the camping cart more convenient and stable when it is folded.

A foldable camping cart according to the fourth aspect includes a first frame and a second frame, the first frame and the second frame being folded and unfolded by means of a folding mechanism, the folding mechanism being configured at a bottom of the camping cart to be adapted for load-bearing, where the folding mechanism includes: an upper folding member, which is operable to be folded upwards; a lower folding member, which is foldable upwards and is configured to support the upper folding member in a preset position in an unfolded state; and a linkage component configured to connect the upper folding member and the lower folding member to the first frame and to hold the upper folding member in the preset position in the unfolded state, where the linkage component includes a first connecting link and a second connecting link pivotally connected to each other, the first connecting link is pivotally connected to the first frame, the upper folding member is pivotally connected to the first connecting link, and the lower folding member is pivotally connected to the second connecting link; and when the upper folding member is folded upwards, the upper folding member can drive, through the linkage component, the lower folding member to fold upwards along with the upper folding member.

Further, the linkage component is configured to connect the upper folding member and the lower folding member to the second frame.

Further, the first connecting link and the second connecting link are connected to each other by a pivot shaft, and the upper folding member is pivotally connected to the pivot shaft.

Further, the first connecting link is provided with a catch portion, and the second connecting link is provided with a catch groove adapted to the catch portion, so as to remain the first connecting link and the second connecting link in the unfolded state.

Further, there are four linkage components, which are provided at four corners of the upper folding member, respectively.

Further, the upper folding member includes a first hinge plate and a second hinge plate pivotally connected to each other, the first hinge plate being connected to the first frame by means of the linkage component, and the second hinge plate being connected to the second frame by means of the linkage component.

Preferably, each of the first hinge plate and the second hinge plate includes a plurality of longitudinal bars extending in a length direction of the camping cart, and a first transverse bar and a second transverse bar extending in a width direction of the camping cart, the plurality of longitudinal bars being attached to the first transverse bar and the second transverse bar.

Further, the lower folding member includes a third hinge plate and a fourth hinge plate pivotally connected to each other, the third hinge plate being pivotally connected to the first frame, and the fourth hinge plate being pivotally connected to the second frame.

Preferably, each of the third hinge plate and the fourth hinge plate includes at least one pole extending in a length direction of the camping cart.

Further, the first frame and the second frame are provided, on tops thereof, with a support member adapted to support a functional unit, a first end of the support member being pivotally connected to the first frame, and a second end of the support member being detachably connected to the second frame.

Further, the support member includes a first rod unit and a second rod unit pivotally connected to each other for storage of the support member.

With the above technical solutions, the present application has the following technical effects.

Firstly, the folding mechanism in the present application includes an upper folding member, a lower folding member, and a linkage component by which the upper folding member and the lower folding member are connected to the camping cart to enable folding and unfolding of the camping cart. Moreover, in an unfolded state, the linkage component can hold the upper folding member and the lower folding member in an unfolded position to make the camping cart more stable when unfolded. Meanwhile, the upper folding member and the lower folding member adopt a stacked structural design, which can improve the load-bearing capacity at the bottom of the camping cart and enhance the user experience.

Secondly, the upper folding member, when folded upwards, can drive, through the linkage component, the lower folding member to fold upwards along with the upper folding member, so as to enable the synchronous folding movement of the upper folding member and the lower folding member. In addition, the upper folding member, the linkage component, and the lower folding member are pivotally connected to each other, and form a four-link mechanism therebetween, enabling a more labor-saving and stable operation during the folding process. When the camping cart needs to be folded or unfolded, the whole camping cart can be folded and stored simply by driving the upper folding member up and down, which is convenient for users to fold and unfold the camping cart.

In a fifth aspect, the present application further provides an outdoor camping device, including the camping cart as described above in the fourth aspect.

Further, the camping cart has a weather shelter detachably mounted on a top thereof, the weather shelter including a canopy and a skeleton for supporting the canopy, where the skeleton includes: a plurality of upright rods arranged in a vertical direction; an auxiliary skeleton configured to form a connection among the plurality of upright rods and to separate the plurality of upright rods from each other; and a main skeleton coupled to the upright rods and configured to support the canopy in a deployed state, where the main skeleton includes a plurality of cross rods and a connecting frame for connecting the plurality of cross rods, each of the cross rods having one end portion coupled to the connecting frame, and the other end portion extending outwards from the connecting frame to support the canopy.

Preferably, the connecting frame includes two connecting seats, which are provided with insertion portions for insertion and assembly of the cross rods.

Preferably, the connecting frame further includes two main connecting rods for connecting the two connecting seats, the two main connecting rods being parallel to each other.

Further, mounting seats are coupled on tops of the upright rods, respectively, and the main skeleton and the auxiliary skeleton are both assembled to the mounting seats.

Preferably, a slanting pole is connected between each of the mounting seats and a respective cross rod, and extends at an angle from the mounting seat towards the cross rod.

Further, the auxiliary skeleton includes at least two auxiliary connecting rods which form a connection among the mounting seats, the auxiliary connecting rods crossing each other to form a connection between two of the mounting seats opposite to each other.

Preferably, the auxiliary skeleton further includes a crossing member configured to connect the auxiliary connecting rods in a cross shape.

Further, each of the mounting seats includes an upper seat body and a lower seat body separable from each other, where the cross rods are coupled to the upper seat bodies of the mounting seats, respectively, the upright rods are coupled to the lower seat bodies of the mounting seats, respectively, and the auxiliary skeleton is coupled to the lower seat bodies of the mounting seats.

Preferably, the upper seat body is provided with a fitting portion which extends downwards, the lower seat body is provided with a fitting groove adapted to the fitting portion, and the upper seat body is provided with a locking member for holding the fitting portion in the fitting groove; and the upper seat body is provided with a through hole extending in a radial direction thereof, the through hole being configured for the cross rod to pass through.

The skeleton for the canopy in the present application is provided with a main skeleton on the top thereof, which includes a plurality of cross rods and a connecting frame for connecting the plurality of cross rods. The cross rod has one end portion coupled to the connecting frame, and the other end portion extending outwards from the connecting frame to support the canopy. With this structure, a stable support can be formed in the middle of the top of the skeleton for the canopy, such that the canopy can be effectively supported. Moreover, the cross rods extend outwards, such that the support area for the canopy is increased, enabling better sunshade protection.

### BRIEF DESCRIPTION OF DRAWINGS

To more clearly illustrate technical solutions in embodiments of the present application, the accompanying drawings of the embodiments will be briefly described below. It is apparent that the drawings in the following description only relate to some of the embodiments of the present application, and are not intended to limit the present application.

FIG. 1 is a schematic diagram of a foldable cart frame in Embodiment I in an unfolded state.

FIG. 2 is a side view of the foldable cart frame in Embodiment I.

FIG. 3 is a top view of the foldable cart frame in Embodiment I.

FIG. 4 is a front view of the foldable cart frame in Embodiment I.

FIG. 5 is a rear view of the foldable cart frame in Embodiment I.

FIG. 6 is a view illustrating a three-frame structure of the foldable cart frame in Embodiment I.

FIG. 7 is a structural view of a lateral hinge in Embodiment I.

FIG. 8 is a structural view of a bottom hinge in Embodiment I.

FIG. 9 is a schematic diagram of a folding linkage structure for the lateral hinge and the bottom hinge in Embodiment I.

FIG. 10 is a schematic diagram illustrating the foldable cart frame in Embodiment I in a folded state.

FIG. 11 is a schematic diagram illustrating the foldable cart frame in Embodiment I in another folded state.

FIG. 12 is an enlarged view of portion A in FIG. 11.

FIG. 13 is a schematic exploded view of a locking apparatus from a perspective.

FIG. 14 is a schematic exploded view of the locking apparatus from another perspective.

FIG. 15 is a schematic structural diagram of the cart frame in Embodiment I combined with functional units.

FIG. 16 is a schematic diagram illustrating a structure with functional units removed in Embodiment I.

FIG. 17 is a schematic structural diagram of a support bar in Embodiment I.

FIG. 18 is a schematic structural diagram of the cart frame in Embodiment I combined with a storage lining.

FIG. 19 is a schematic diagram of a foldable cart frame in Embodiment II combined with functional units, in an unfolded state.

FIG. 20 is a schematic diagram of the foldable cart frame in Embodiment II with functional units removed, in an unfolded state.

FIG. 21 is a schematic structural diagram of a locking apparatus in Embodiment II.

FIG. 22 is a first schematic diagram of the foldable cart frame in Embodiment II in a folded state.

FIG. 23 is a second schematic diagram of the foldable cart frame in Embodiment II in a folded state.

FIG. 24 is a schematic structural diagram of a camping cart in Embodiment III combined with a weather shelter.

FIG. 25 is a schematic diagram of a structure with a canopy removed in Embodiment III.

FIG. 26 is a schematic structural diagram of a truss component in a skeleton system.

FIG. 27 is a schematic structural diagram of an upper pole in a skeleton system.

FIG. 28 is a schematic structural diagram of a camping cart in Embodiment IV.

FIG. 29 is a schematic diagram illustrating a bottom structure of a camping cart in Embodiment IV.

FIG. 30 is a side view of a camping cart in Embodiment IV.

FIG. 31 is a schematic structural diagram of a folding mechanism in Embodiment IV.

FIG. 32 is an exploded view of a folding mechanism in Embodiment IV.

FIG. 33 is an exploded view of a linkage component in Embodiment IV.

FIG. 34 is a schematic diagram of a camping cart in Embodiment IV in a folded state.

FIG. 35 is an enlarged view of portion A in FIG. 34.

FIG. 36 is a schematic diagram of a camping cart in Embodiment IV in a folded state from another perspective.

FIG. 37 is a schematic structural diagram of a skeleton for a canopy in Embodiment V.

FIG. 38 is a schematic diagram illustrating a partial structure of a skeleton for a canopy in Embodiment V.

FIG. 39 is a top view of a main skeleton in Embodiment V.

FIG. 40 is a schematic structural diagram of a slanting pole in Embodiment V.

FIG. 41 is a schematic diagram of a connection structure between a mounting seat and an auxiliary skeleton in Embodiment V.

FIG. 42 is an exploded structural diagram of a mounting seat in Embodiment V.

FIG. 43 is a schematic diagram illustrating a combined state of a weather shelter and a camping cart in Embodiment V.

### DESCRIPTION OF REFERENCE NUMERALS

100-cart frame; 1-first frame; 12-catch bar; 2-second frame; 11, 21-snap-in shaft; 3-middle frame; 31-lateral column; 311-opening; 32-guide rod; 4-locking apparatus; 41-locking member; 410-mounting hole; 411-locking portion; 412-guide slider; 413-protrusion; 415-shaft portion; 42-locking base; 420-groove; 421-baffle portion; 43-force-applying member; 5-first folding component; 51-lateral hinge; 51a-first hinge plate; 51b-second hinge plate; 51c-pivot locking structure; 52-bottom hinge; 52a-third hinge plate; 52b-fourth hinge plate; 52c-limit block; 6-second folding component; 7-end corner member; 8-first housing; 9-second housing; 10-handle; Q1-first storage cavity; Q2-second storage cavity; 20-folding linkage mechanism; 201-first connecting link; 202-second connecting link; 203-third connecting link; 110-support apparatus; 111-support bar; 111a-support portion; 111b-limit portion; 111c-positioning groove; 120-functional unit; 130-storage lining; 300-skeleton system; 310-support column; 320-truss component; 321-connecting rod; 322-connecting seat; 322a-upper seat body; 322b-fitting portion; 322c-upper hole; 322d-lower seat body; 322e-fitting groove; 322f-lower hole; 323-crossing member; 324-locking bolt; 330-pole component; 331-upper pole; 332-lower pole; 33a-pole body; 33b-connecting rope; 33c-attaching portion; 400-canopy; 500-folding mechanism; 501-upper folding member; 501a-first hinge plate; 501b-second hinge plate; 501c-pivot hole; 501d-first end surface; 502-lower folding member; 502a-third hinge plate; 502b-fourth hinge plate; 502c-first pivot portion; 502d-second pivot portion; 502e-second end surface; 503-linkage component; 503a-first connecting link; 503b-second connecting link; 503c-catch portion; 503d-catch groove; 503e-pivot shaft; 600-support member; 601-first rod unit; 602-second rod unit; 3000-skeleton; 3001-upright rod; 3002-auxiliary skeleton; 3021-auxiliary connecting rod; 3022-crossing member; 3003-main skeleton; 3031-connecting frame; 3311-connecting seat; 3312-main connecting rod; 3032-cross rod; 3004-mounting seat; 3041-upper seat body; 3411-through hole; 3412-fitting portion; 3042-lower seat body; 3421-fitting groove; 3043-locking member; 3005-slanting pole; 3051-catch groove; 3052-support sleeve; 400-canopy; 1000-camping cart.

### DETAILED DESCRIPTION

To clarify the objectives, technical solutions and advantages of the embodiments of the present application, the present application will be described in further detail below in conjunction with the accompanying drawings. In general, components in the embodiments of the present application described and illustrated in the accompanying drawings herein may be arranged and designed in a variety of different configurations. Based on the embodiments of the present application, all other embodiments obtained by those ordinary skilled in the art without any creative efforts fall within the scope of protection of the present application.

It should be noted that similar reference numerals and letters indicate similar items in the following drawings. Therefore, once an item is defined in one drawing, it does not need to be further defined and explained in subsequent drawings.

Unless otherwise defined, technical or scientific terms used herein shall have the ordinary meanings as understood by those ordinary skilled in the art to which the present application pertains. Terms “first”, “second”, and the like used in the specification and claims of the present application do not indicate any order, quantity or importance, but are used only to distinguish between different components. Similarly, terms “a”, “an”, “one”, or “the” and the like do not indicate a limitation on quantity, but rather indicate the presence of at least one. Terms such as “including” or “comprising” mean that elements or items appearing before “including” or “comprising” cover elements or items listed after “including” or “comprising” and their equivalents, and do not exclude other elements or items. Terms such as “center”, “upper”, “lower”, “left”, “right”, “vertical”, “horizontal”, “inside”, or “outside” are only used to indicate relative positional relationships, and when the absolute position of the described object is changed, the relative positional relationships may be changed accordingly. They are only for the convenience of describing the present application and simplifying the description, and are not intended to indicate or imply that the apparatus or element referred to must have a specific orientation, be constructed and operated in a specific orientation, and therefore cannot be construed as a limitation of the present application.

In the description of the present application, it should be noted that unless otherwise expressly specified and limited, terms “mounted”, “connected”, or “coupled” should be understood in a broad sense, e.g., it may be a fixed connection, a detachable connection, or an integral connection; it may be a mechanical connection or an electrical connection; it may be a direct connection or an indirect connection through an intermediate medium; and it may be an internal connection between two elements. For those ordinary skilled in the art, the specific meanings of the above terms in the context of the present application may be understood in specific circumstances.

Some embodiments of the present application will be described in detail below in conjunction with the accompanying drawings. Features in the following embodiments may be combined with each other without conflict.

### Embodiment I

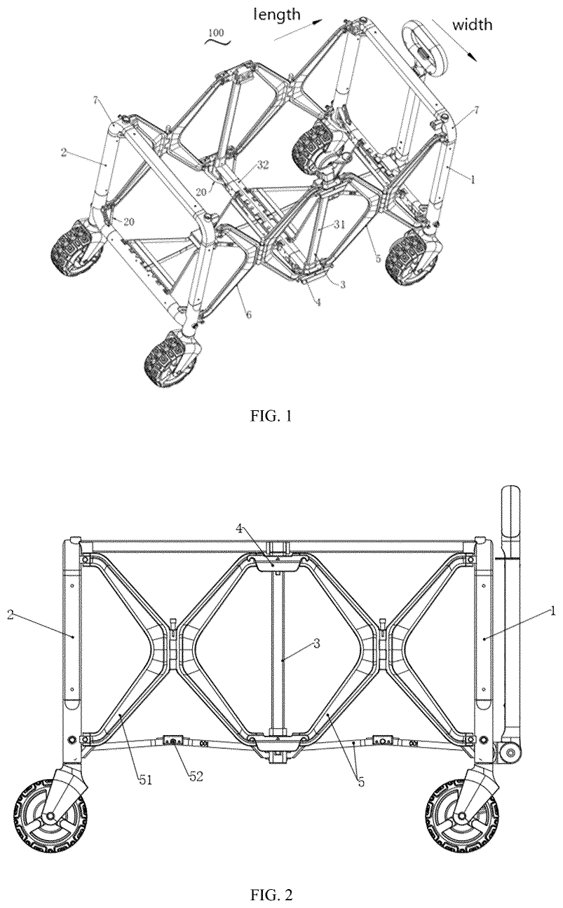

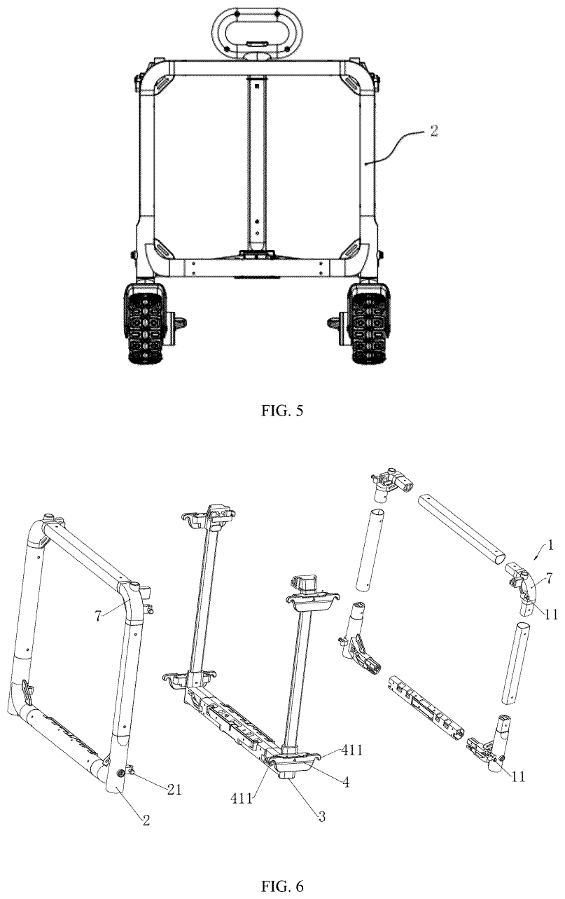

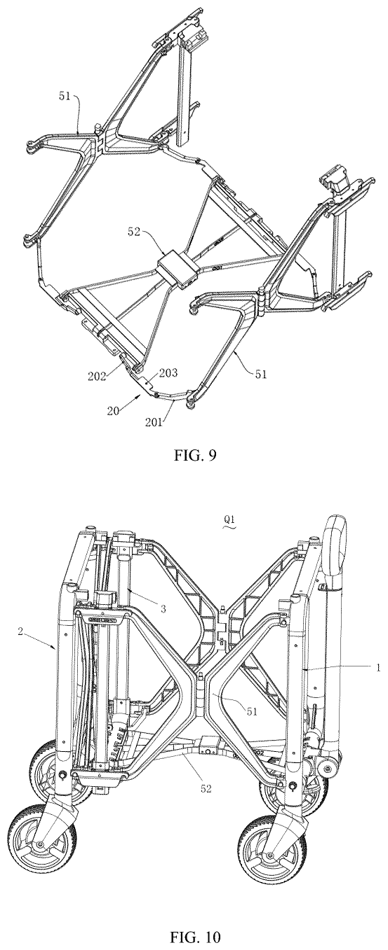

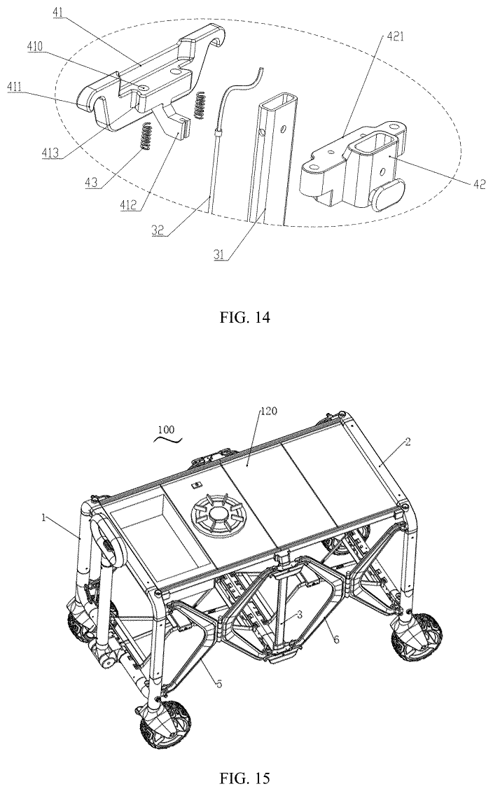

Referring to FIGS. 1 to 18, this embodiment provides a foldable cart frame 100, applied to a portable carrying cart, the foldable cart frame 100 including a first frame 1 and a second frame 2 arranged in a length direction, where the foldable cart frame 100 further includes a middle frame 3 arranged between the first frame 1 and the second frame 2, where the first frame 1 and the middle frame 3 are connected by a first folding component 5 to enable the first frame 1 to be folded and unfolded with respect to the middle frame 3, and a first storage cavity Q1 is formed between the first frame 1 and the middle frame 3 when unfolded; and where the second frame 2 and the middle frame 3 are connected by a second folding component 6 to enable the second frame 2 to be folded and unfolded with respect to the middle frame 3, and a second storage cavity Q2 is formed between the second frame 2 and the middle frame 3 when unfolded. The first folding component 5 and the second folding component 6 are foldable and unfoldable relatively independently of each other. The first storage cavity Q1 and the second storage cavity Q2 are foldable and unfoldable independently of each other.

With the above construction, the cart frame 100 according to the present application forms a three-frame and two-cavity structure, in which the folding of the first folding component 5 between the first frame 1 and the middle frame 3 does not affect the folding of the second folding component 6, and the first folding component 5 and the second folding component 6 can be folded and unfolded independently of each other. When the first folding component 5 and the second folding component 6 are both unfolded, two storage cavities are formed between the first frame 1 and the second frame 2, which is corresponding to a fully-opened state. When one of the first folding component 5 and the second folding component 6 is folded and the other is unfolded, a single storage cavity is formed, which is corresponding to a half-opened state. When the first folding component 5 and the second folding component 6 are folded at the same time, they are in a collapsed state. The two cavities in this embodiment can be independently unfolded and folded, which significantly improves the ease of use of such products.

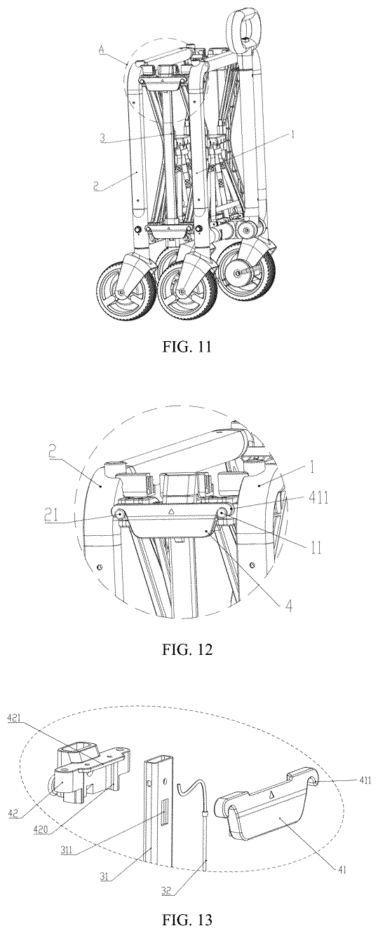

Compared with the foldable cart frame in the related art, the foldable cart frame 100 in this embodiment has a smaller thickness and occupies less space after being folded. In the above-mentioned related art, the folding mechanisms are both folded in a length direction of the cart frame, that is, stacked in the length direction, and thus occupy more space after being folded, which is inconvenient for storage and carrying. To solve the above problem, the first folding component 5 in the present application is configured to fold only inward of the first storage cavity Q1, and the second folding component 6 is configured to fold only inward of the second storage cavity Q2. That is to say, both the first folding component 5 and the second folding component 6 are folded towards the inside of the storage cavity, greatly reducing the space occupied by the folding mechanism in the length direction. It should be noted that in another embodiment, only one folding component can be folded inward of the storage cavity, while the other folding component can be folded in a stacked fashion in the length of the cart, which can also reduce the thickness of the cart frame 100 after being folded to a certain extent. The folded forms in this embodiment are shown with reference to FIGS. 1, 9 and 10, where FIG. 1 shows a fully-opened state, FIG. 10 shows a single-cavity state, and FIG. 11 shows a folded state.

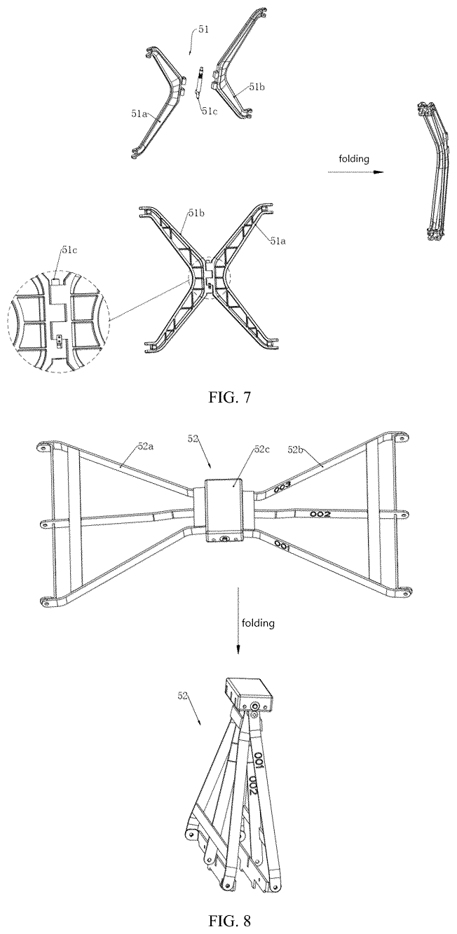

As shown in FIGS. 2 and 7, the first folding component 5 includes two lateral hinges 51 arranged opposite each other in a width direction, each of the lateral hinges 51 including a first hinge plate 51a and a second hinge plate 51b that are pivotally connected to each other, where the first hinge plate 51a is pivotally connected to the first frame 1, and the second hinge plate 51b is pivotally connected to the middle frame 3. The lateral hinge 51 is configured in an X-shape. According to FIG. 7, the first hinge plate 51a and the second hinge plate 51b of the lateral hinge 51 are pivotally connected to each other by a pin in the middle of the lateral hinge 51. During folding, the pin moves towards the inside of the storage cavity, and the first hinge plate 51a rotates around a pin axis provided on the first frame 1 to flip towards the inside of the first storage cavity Q1, and the second hinge plate 51b rotates around a pin axis provided on the middle frame 3 to flip towards the inside of the first storage cavity Q1. The above structure enables the flip-folding of the lateral hinge 51 towards the inside of the storage cavity. To further improve the convenience of use, in this embodiment, a pivot locking structure 51c is further provided on a pivot shaft between the first hinge plate 51a and the second hinge plate 51b. The pivot locking structure 51c keeps the first hinge plate 51a and the second hinge plate 51b in an unfolded state, and prevents the first hinge plate 51a and the second hinge plate 51b from being folded inward when subjected to external forces, thereby improving the stability of the foldable cart frame 100. In particular, the pivot locking structure 51c includes a movable pin movable up and down, and a return spring disposed around the movable pin, and a locking protrusion is provided on the movable pin. Corresponding to the locking protrusion, two locking grooves are provided in the first hinge plate 51a and the second hinge plate 51b, respectively. In the unfolded state, the locking protrusion is snapped into the two locking grooves to achieve snap-in connection, thereby limiting the flipping of the first hinge plate 51a and the second hinge plate 51b. When a user presses the movable pin to disengage it from the locking grooves, the first hinge plate 51a and the second hinge plate 51b are released and can be folded freely, as shown in FIG. 7. It should be noted that the above-mentioned pivot locking structure 51c is also provided in the lateral hinge 51 of the second folding component 6. The pivot locking structure 51c has the technical effect of simple structure and convenient use.

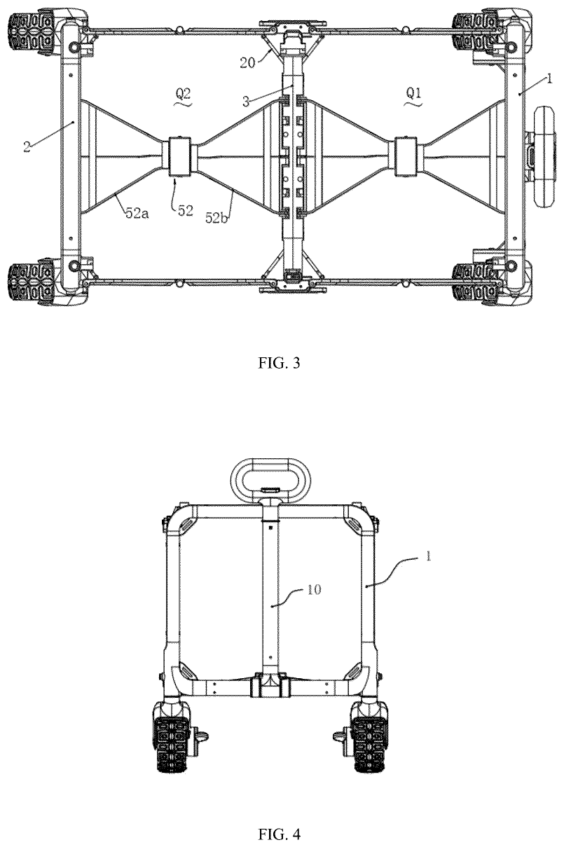

With further reference to FIGS. 3 and 8, the first folding component 5 further includes a bottom hinge 52 extending in the length direction, the bottom hinge 52 including a third hinge plate 52a and a fourth hinge plate 52b that are pivotally connected to each other, where the third hinge plate 52a is pivotally connected to the first frame 1, and the fourth hinge plate 52b is pivotally connected to the middle frame 3. Each of the third hinge plate 52a and the fourth hinge plate 52b includes a plurality of support strips for supporting items. In particular, each of the third hinge plate 52a and the fourth hinge plate 52b includes three support strips, which are connected to each other by a transverse bar, thereby improving the stability of the hinge plate. Further, the third hinge plate 52a and the fourth hinge plate 52b are pivotally connected to each other by a pin, and the third hinge plate 52a is pivotally connected to the first frame 1 by another pin, and the fourth hinge plate 52b is pivotally connected to the middle frame 3 by a pin. During folding, as shown in FIG. 8, the third hinge plate 52a is flipped towards the inside of the first storage cavity Q1 with respect to the first frame 1, and the fourth hinge plate 52b is flipped towards the inside of the first storage cavity Q1 with respect to the middle frame 3. In addition, a limit block 52c is further provided at the joint of the third hinge plate 52a and the fourth hinge plate 52b, and can limit further flipping of the third hinge plate 52a and the fourth hinge plate 52b towards the outside of the first storage cavity in the unfolded state, such that the third hinge plate 52a and the fourth hinge plate 52b can be kept in a substantially horizontal state to facilitate a user to place items in the first storage cavity Q1. The limit block 52c is coupled to a central pivot shaft and has stop portions on both sides thereof for limiting further downward folding of the third hinge plate 52a and the fourth hinge plate 52b.

To enable the folding and unfolding of the first folding component 5 more stable, the two lateral hinges 51 are connected to the bottom hinge 52 via a folding linkage mechanism 20, which is provided such that the bottom hinge 52 can be folded and unfolded in synchronization with the two lateral hinges 51. As shown in FIGS. 1, 3 and 9, the folding linkage mechanism 20 includes a first connecting link 201, a third connecting link 203, and a second connecting link 202 connected in sequence, where the first connecting link 201 is pivotally connected to the lateral hinge 51, the second connecting link 202 is pivotally connected to the bottom hinge 52, and the third connecting link 203 is pivotally connected to the first connecting link 201 and the second connecting link 202 between the first connecting link 201 and the second connecting link 202, so as to transmit movement between the first connecting link 201 and the second connecting link 202. In particular, the first connecting link 201 is configured to rotate around a first pivot shaft, where the first pivot shaft is adapted to connect the first connecting link and the third connecting link, and the second connecting link 202 is configured to rotate around a second pivot shaft, where the second pivot shaft is adapted to connect the second connecting link and the third connecting link. The first pivot shaft and the second pivot shaft are perpendicular to each other, which allows the first connecting link 201 to rotate left and right in a horizontal plane and the second connecting link 202 to rotate up and down in a vertical plane.

During transmission of the movement, the first connecting link 201 is configured to rotate around the first pivot shaft within a range of a first angle, the range of the first angle being configured to be able to synchronously drive the third connecting link 203 to move during rotation of the first connecting link 201. The second connecting link 202 is configured to rotate around the second pivot shaft within a range of a second angle, the range of the second angle being configured to be able to synchronously drive the third connecting link 203 to move during rotation of the second connecting link 202. The first connecting link 201 and the second connecting link 202 are both limited in rotation when the third connecting link 203 is not moving. The first angle is an angle between the first connecting link 201 and the third connecting link 203 in an axial direction, the first angle ranging from 0 degrees to 45 degrees. The second angle is an angle between the second connecting link 202 and the third connecting link 203 in an axial direction, the second angle ranging from 0 degrees to 90 degrees. The first connecting link 201 and the second connecting link 202 each rotate within a set angle range during the movement, and thus have the effect of limiting the flip angles of the first folding component and the second folding component. Under the linkage action of the folding linkage mechanism 20, the first folding component and the second folding component can be stably folded and unfolded synchronously, such that the cart frame 100 can switch more stably between the folded state and the unfolded state.

The folding linkage mechanism 20 is correspondingly provided on the middle frame 3, the first frame 1, and the second frame 2. Each of the middle frame 3, the first frame 1, and the second frame 2 has a sliding seat at the bottom thereof for positioning the third connecting link 203 and allowing the third connecting link 203 to move in its axial direction, making the movement of the third connecting link 203 more stable, and thus enabling stable movement of the folding linkage mechanism 20.

To facilitate assembly and reduce structural costs, the first folding component 5 and the second folding component 6 in this embodiment are symmetrically arranged with respect to the middle frame 3, and have substantially the same structural configuration, as shown in FIGS. 1 to 3. In other words, the second folding component 6 is the same as the first folding component 5, including a pair of lateral hinges 51 and a bottom hinge 52, and both the lateral hinges 51 and the bottom hinge 52 are folded inward. It should be noted that the specific implementation of the folding component as described above is only one of implementations for realizing the inventive purpose of the present application, not all of the implementations, and cannot constitute the only limitation on the scope of protection of the present application. For those skilled in the art, any non-creative modifications made to the first folding component 5 and the second folding component 6 inspired by the above implementation should fall within the scope of protection of the present application.

In this embodiment, a three-frame structure is shown in FIG. 6. The middle frame 3 is configured in a U-shape, and the first frame 1 and the second frame 2 are both configured in a rectangle shape. The middle frame 3 includes two lateral columns 31 arranged opposite each other in the width direction, and a bottom beam for connecting the two lateral columns 31. Both ends of the bottom beam are fixedly connected to the two lateral columns 31, respectively, where the lateral column 31 provides a pivot structure for the two lateral hinges 51, and the bottom beam provides a pivot structure for two bottom hinges 52 and a guide structure for guiding the folding linkage mechanism 20. The first frame 1 and the second frame 2 can be independently folded towards a side of the lateral column 31. To facilitate movement of the cart, wheels are mounted on both the first frame 1 and the second frame 2, and a handle 10 is attached to the first frame 1 for a user to tow the cart, as shown in FIGS. 1 and 4. In addition, the first frame 1 and the second frame 2 are located on the left and right sides of the middle frame 3, respectively, and provide a pivot base for the lateral hinge 51 and the bottom hinge 52.

Referring to FIG. 6, each of the first frame 1 and the second frame 2 includes a pair of vertical bars arranged at an interval in the width direction of the camping cart, at least one horizontal bar extending in the width direction, and an end corner member 7 for connecting the horizontal and vertical bars. The end corner member 7 includes: a horizontal bar fitting portion adapted for fit-connection with the horizontal bar; and a vertical bar fitting portion adapted for fit-connection with the vertical bar. The horizontal bar has a groove adapted to surround a periphery of the horizontal bar fitting portion, and the vertical bar has a groove adapted to surround a periphery of the vertical bar fitting portion.

To prevent the first folding component 5 and the second folding component 6 from unfolding on their own in the folded state, in this embodiment, at least one locking apparatus 4 is further provided on the middle frame 3. Referring to FIGS. 10 to 14, the locking apparatus 4 is configured to lock the first frame 1 and/or the second frame 2 to the middle frame 3. In particular, the locking apparatus 4 can lock one of the first frame 1 and the second frame 2 to the middle frame 3, or lock both of the first frame 1 and the second frame 2 to the middle frame 3. In this embodiment, both of the first frame 1 and the second frame 2 are locked to the middle frame 3, thereby providing stability for the cart frame 100 in the folded state. Referring to FIG. 12, the locking apparatus 4 includes: a first locking portion 411 for locking the first frame 1 to keep the first folding component 5 in the folded state; and a second locking portion 411 for locking the second frame 2 to keep the second folding component 6 in the folded state. The first locking portion 411 and the second locking portion 411 are both hook-shaped portions, and snap-in shafts 11, 21 fit with the hook-shaped portions are provided on the first frame 1 and the second frame 2. As each of the snap-in shafts 11, 21 approaches the locking apparatus 4, a corresponding locking portion 411 can be pushed to move, enabling snap-in connection between the two.

Referring to FIGS. 10 to 13, the locking apparatus 4 includes a locking member 41 movably attached to the middle frame 3. The locking member 41 has the first locking portion 411 and the second locking portion 411. The movable attachment enables the locking member 41 to move between a locked position and an unlocked position. In this embodiment, the locking member 41 is configured to be slidable up and down. In particular, the middle frame 3 is provided with a locking base 42 adapted to the locking member 41, and the locking member 41 is slidably fit with the locking base 42. A force-applying member 43 is arranged between the locking member 41 and the locking base 42, and is configured to apply force to the locking member 41 in a direction to maintain the locking. In this embodiment, the force-applying member 43 is a spring, and the locking member 41 is provided with a mounting hole 410 for mounting the spring. The locking base 42 is provided with a baffle portion 421, and the spring is mounted between the mounting hole 410 and the baffle portion 421. The baffle portion 421 compresses the spring to provide a downward force to the locking member 41, so as to keep the locking member 41 in the locked position.

With continued reference to FIGS. 10 to 14, a protrusion 413 and a groove 420 matched with each other are further provided between the locking member 41 and the locking base 42, serving as sliding guides to make the movement of the locking member 41 smoother. The middle frame 3 is further provided with a guide rod 32 for guiding the locking member 41 to move up and down, and the locking member 41 is slidably fit with the guide rod 32. In this embodiment, the middle frame 3 includes a hollow lateral column 31, and the guide rod 32 is located in the lateral column 31 and fixed to the locking base 42. The lateral column 31 is provided with an opening 311, such that a portion of the locking member 41 may be inserted into the opening 311 to slide with the guide rod 32. In this embodiment, the locking member 41 is provided with a guide slider 412 protruding into the opening 311, and the guide slider 412 is provided with a semi-circular notch in the middle thereof that cooperates with the guide rod 32, enabling the locking member 41 to slide up and down along the guide rod 32.

With continued reference to FIGS. 11 to 14, the locking portions 411 are constructed as hooks, and the snap-in shafts 11, 21 are constructed on the first frame 1 and the second frame 2 and adapted to the hooks. In particular, the snap-in shaft 11 is attached to a side wall of the end corner member 7, and the hook is opened in a direction in which the locking member 41 is subjected to an elastic force from the force-applying member 43. In this embodiment, the locking member 41 is subjected to the elastic force from the force-applying member 43 in a downward direction and the hook is opened downwards. In this embodiment, the snap-in shaft 11, 21 is further provided with a shaft cap on a free end thereof to axially block the locking portion 411 fit on the snap-in shaft 11, 21, preventing the locking portion 411 from disengaging from the snap-in shaft 11, 21 axially, and ensuring a more reliable connection state.

In this embodiment, as shown in FIG. 10, the middle frame 3 has a locking apparatus 4 on each of upper and lower sides thereof, the guide rod 32 being connected between the upper and lower locking apparatuses 4. In this embodiment, the locking apparatus 4 is configured as two sets of locking apparatuses 4 arranged opposite each other in the width direction of the cart frame 100, where each set of locking apparatuses 4 includes two locking apparatuses 4 respectively arranged on the upper and lower sides of the middle frame 3, that is, the number of the locking apparatuses 4 is set to four.

The above cart frame 100 can be applied to various portable carrying carts, such as camping carts, shopping carts, or handcarts.

With continued reference to FIGS. 15 to 17, in this embodiment, the camping cart has a support apparatus 110 on a top thereof, the support apparatus 110 including at least one pair of support bars 111 arranged opposite each other in the width direction of the camping cart, the support bars 111 extending in the length direction of the camping cart, where the pair of support bars 111 are configured such that the support bars are adapted to support a functional unit 120 across the storage cavity in the width direction and to limit movement of the functional unit 120 in the width direction.

The support bar 111 includes a support portion 111a and a limit portion 111b. The support portion 111a is configured to support the functional unit 120, and the limit portion 111b is configured to limit the movement of the functional unit 120 in the width direction. In this embodiment, the support portion 111a and the limit portion 111b are designed to be integrally formed, as shown in FIG. 17, where the support portion 111a is disposed on a side of the limit portion 111b, which facilitates the lap connection between the support bar 111 and the cart frame 100, as well as the assembly of the functional unit 120. When placing the functional unit 120, a bottom surface of an end portion of the functional unit 120 is supported by the support portion 111a, and a side surface of an end portion of the functional unit 120 is pressed against the limit portion 111b, thereby limiting the movement of the functional unit 120 in the width direction and stabilizing the placement of the functional unit 120. In some embodiments, to make the placement of the functional unit 120 on the support bar 111 more stable, magnetic attraction can be used to fix them, such that the functional unit 120 can be attracted to the support bar 111, thereby limiting the movement of the functional unit 120. For example, a magnetic member may be provided on the support bar 111, and a magnetic member or an accessory made of a magnetic material may be attached to the functional unit 120. However, other methods can be used to limit and fix the functional unit 120.

With continued reference to FIG. 15, in some embodiments, the functional unit 120 is an IGT (Iron Grill Table) unit. A distance between the limit portions 111b of the pair of support bars 111 in the width direction is 300 mm to 500 mm to be suitable for placing the IGT unit. In particular, an IGT unit has a size of about 250 mm×360 mm. In this embodiment, the distance is selected to be 350 mm to 400 mm, which allows the functional unit 120 to be placed across the pair of support bars 111 in a length direction thereof, such that the foldable cart frame 100 can support a plurality of functional units 120 for use, meanwhile, this distance also leaves space for the support portion 111a to support the bottom of the functional unit 120, making the placement of the functional unit 120 more stable. Preferably, the distance between the limit portions 111b of the pair of support bars 111 in the present application is about 364 mm so as to match an IGT unit, while leaving some gaps to overcome the effects of dimensional errors in components and parts and to facilitate mounting of the IGT unit by personnel. Further, a length of the foldable cart frame 100 is greater than 200 mm to accommodate at least one functional unit 120. Preferably, in this embodiment, the length of the foldable cart frame 100 is about 820 mm to accommodate the support bar 111 with a length of about 756 mm, which means that three IGT units can be placed in the length direction to accommodate a table board, stove, and basin at the same time, meeting people's cooking and washing requirements and making it more convenient to use.

Referring to FIGS. 15 to 17, in this embodiment, in order not to affect the folding of the foldable cart frame 100, the support bar 111 is detachably attached to the top of the foldable cart frame 100, and the corresponding support bar 111 is separated from the foldable cart frame 100 in the folded state, so as to improve the convenience of use. Both ends of the support bar 111 are respectively lapped on the middle frame 3 and one of the first frame 1 and the second frame 2. The support bar 111 is supported by the middle frame 3 located in the middle of the cart frame 100, which can reduce the length of the support bar 111, ensure the support strength of the support bar 111, and facilitate production. In addition, the first frame 1 and the second frame 2 are configured to be folded and unfolded independently of each other with respect to the middle frame 3. In this way, users can, according to their use requirements, only fold and unfold the first frame 1 or the second frame 2, and at the same time remove the corresponding support bar 111, such that the foldable cart frame 100 is in a half-opened state. Both of the first frame 1 and the second frame 2 can be unfolded, in which case the foldable cart frame 100 is in a fully-opened state, which can help users solve some problems that affect the use due to insufficient space, making it flexible and convenient to use.

Referring to FIG. 15, the support apparatus 110 in the present application can be used in conjunction with a plurality of functional units 120, including table boards, stoves, or basins. The camping cart, due to its own height, can be used to set up the functional units 120. Therefore, users do not need to perform additional setting-up work when using the functional units 120, and can directly set up the functional units 120 on the support apparatus 110, which not only improves the convenience of use when camping, but also reduces the number of items that users need to carry when camping. In addition, the functional unit 120 can be made into a standard component, such as an IGT unit, which can facilitate the setting-up and replacement of the functional unit 120, further improving the convenience of users in using the functional unit 120.

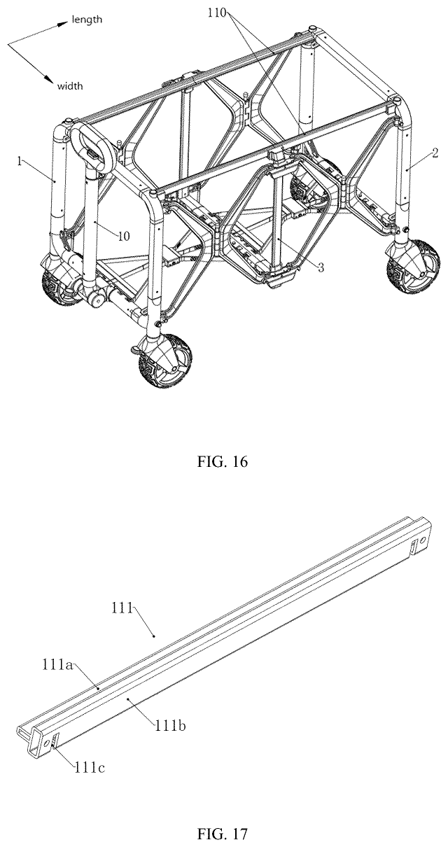

The end corner member 7 has a positioning portion extending in the length direction, to which the support bar 111 is detachably attached, as shown in FIGS. 15 and 16. There are two support bars 111 arranged in the length direction of the cart frame 100, and the support bar 111 has positioning grooves 111c symmetrically provided on both ends thereof, so as to be coupled with the positioning portions and fix the support bar 111 in a limited position. When the cart frame 100 needs to be folded, the support bar 111 can be quickly removed from the cart frame 100 for ease of folding. When the cart frame 100 is unfolded for use, the positioning grooves 111c on both ends of the support bar 111 can be simply aligned and coupled with the positioning portions on the end corner members 7, making it simple and convenient to mount. In addition, the end corner member 7 further has an expansion interface suitable for connecting a canopy component (i.e., a weather shelter hereinafter), which has a plurality of support columns 310 arranged vertically, and the expansion interface is detachably connected to the support column 310. A hole is formed inside the expansion interface, and has a guide groove and a catch groove constructed in a side wall thereof. The support column 310 has a catch protrusion adapted to be embedded into the catch groove under the guidance of the guide groove to lock the support column 310.

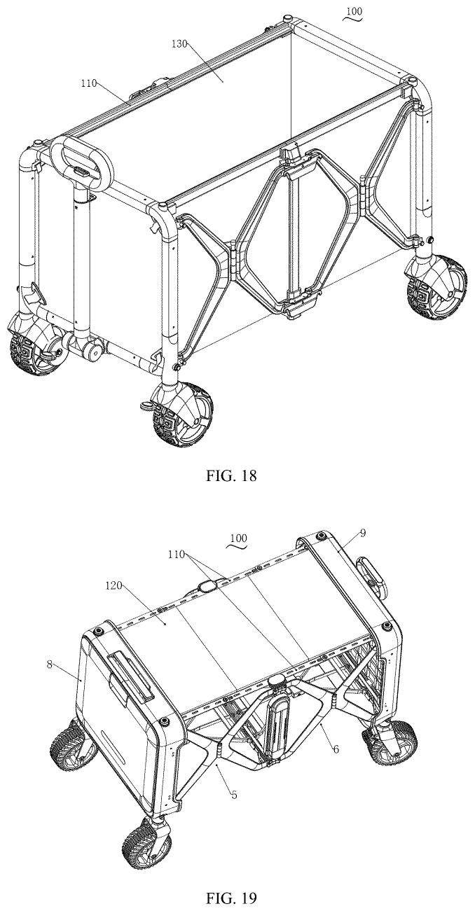

Referring to FIG. 18, in this embodiment, the camping cart is equipped with a detachable storage lining 130 for better acceptance of items. In particular, the end corner member 7 is provided with a catch groove, and the storage lining 130 is provided with a connecting member. The connecting member is configured to pass through the catch groove and fix the storage lining 130 to the cart frame 100. For example, the connecting member is a strap, tie, or the like, which is simple and convenient to connect.

### Embodiment II

As shown in FIGS. 19 to 23, a camping cart in this embodiment includes a cart frame 100, which is the foldable cart frame 100 in Embodiment I as described above. A first housing 8 is fixedly connected to the first frame 1 and a second housing 9 is fixedly connected to the second frame 2, for example, with fasteners such as bolts. When the first folding component 5 and the second folding component 6 are both in the folded state, an accommodating cavity is formed between the first housing 8 and the second housing 9 to accommodate the cart frame 100.

In the present application, based on the need to form an accommodating cavity in the two housings, a cavity may be formed in the first housing 8 or the second housing 9, or concave cavities may be provided in both the first housing 8 and the second housing 9, as long as the two housings, when combined, can form an accommodating cavity for accommodating the cart frame 100. In this embodiment, a technical scheme is adopted where the two housings are provided with concave cavities. In particular, the first housing 8 has a first cavity recessed towards a side away from the middle frame 3, the second housing 9 has a second cavity recessed towards the side away from the middle frame 3, and the first and second cavities are combined to form the accommodating cavity.

Referring to FIG. 23 in which the camping cart in this embodiment is in the folded state, the camping cart is constructed in a box shape, for example, in a shape of a suitcase or toolbox, which is both aesthetically pleasing and convenient to carry.

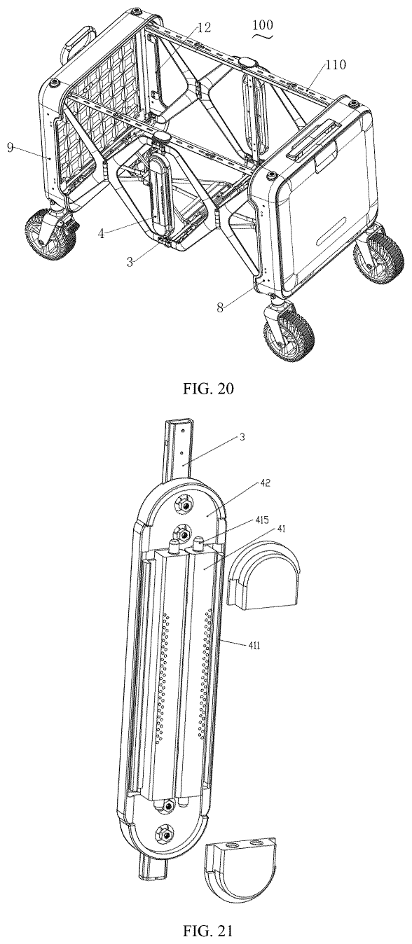

Further, to enable the box-shaped camping cart to be closed more tightly in the folded state, a locking apparatus 4 is proposed in this embodiment, and has a different structure from that in Embodiment I. In this embodiment, the locking apparatus 4 includes a locking member 41 configured to rotate around an axis. As shown in FIGS. 20 and 21, the middle frame 3 is provided with a locking base 42 adapted to the locking member 41. The locking base 42 is fixed to the middle frame 3, and the locking member 41 is pivotally connected to the locking base 42. The locking member 41 has a shaft portion 415, and can rotate around an axis of the shaft portion 415. Similar to Embodiment I, a force-applying member 43 is arranged between the locking member 41 and the locking base 42, and is configured to apply force to the locking member 41 in a direction to maintain the locking. In this embodiment, the locking portion 411 is constructed as a hook, and a catch groove adapted to the hook is constructed in each of the first frame 1 and the second frame 2. In conjunction with FIG. 20, the first frame 1 and the second frame 2 are provided with a catch strip 12, which is formed with the catch groove adapted to the locking portion 411 constructed as a hook. In this embodiment, the catch strip 12 is mounted and fixed to the first housing 8 and the second housing 9 to form the catch groove. In other embodiments, the catch groove can be directly formed on the first housing 8 or the second housing 9. In this embodiment, the locking apparatus 4 is configured as two sets of locking apparatuses arranged opposite each other in the width direction of the cart frame 100, where each set of locking apparatuses 4 includes two locking apparatuses 4 respectively arranged on the left and right sides of the middle frame 3. In this embodiment, the locking apparatus 4 is configured to match the shape between the first housing 8 and the second housing 9, making the box-shaped camping cart closed more tightly in the folded state, thereby improving the aesthetics of the camping cart.

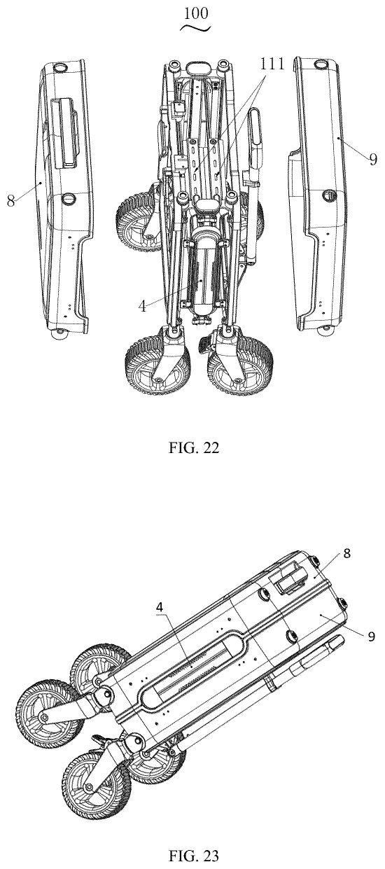

Referring to FIGS. 20 and 22, this embodiment differs from Embodiment 1 in the manner in which the support bar 111 is mounted to the foldable cart frame 100. The foldable cart frame 100 in this embodiment includes a first frame 1, a middle frame 3, and a second frame 2. A plurality of support bars 111 are arranged in the length direction of the foldable cart frame 100. There are two support bars 111 pivotally connected to each other and arranged between the middle frame 3 and the first frame 1 or the second frame 2. The support bars 111 located at both ends in the length direction are pivotally connected to the corresponding first frame 1 or second frame 2, respectively. The support bars 111 arranged in the middle are pivotally connected to the middle frame 3. With the above structural design, when the foldable cart frame 100 is folded, the plurality of support bars 111 can be synchronously flipped to fold towards the inside of the cart frame 100, which not only saves space, but also eliminates the need to disassemble the plurality of support bars 111, improving the convenience of use.

In some embodiments, the support bars 111 arranged in the middle are detachably supported on the middle frame 3. In particular, as shown in FIGS. 20 and 22, one end of the support bar 111 has a pivot portion that is pivotally connected to the first frame 1 or the second frame 2, and the other end has a buckle bending and extending downwards. Accordingly, the middle frame 3 has a groove corresponding to the buckle. When in use, the end of the support bar 111 close to the middle frame 3 can be separated from the middle frame 3, the support bar 111 is folded separately to be stored in the folded foldable cart frame 100, without the need to disassemble the support bar 111 before folding the cart frame 100, reducing the probability of losing the disassembled support bar 111 and improving the convenience of folding the cart frame 100.

Furthermore, the support bars 111 located at both ends in the length direction are detachably and pivotally connected to the corresponding first frame 1 or second frame 2. With this structural design, the support bars 111 can be separated from the foldable cart frame 100, which facilitates the folding and storage of the cart frame 100 and further reduces the volume of the cart frame 100 after folding.

Further, to improve the storage capacity of the box-shaped camping cart, one of the first housing 8 and the second housing 9 is provided with a flip-open storage cover on a side wall thereof for placing some small items. However, in other embodiments, both the first housing 8 and the second housing 9 can be provided with flip-open storage covers on side walls thereof.

### Embodiment III

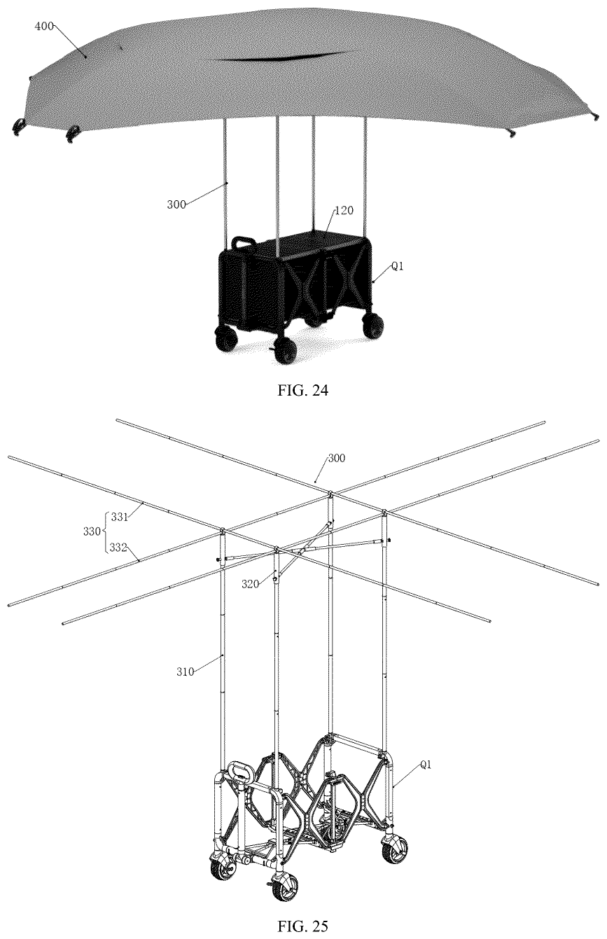

Referring to FIGS. 24 to 27, this embodiment provides an outdoor camping device, including a camping cart. This embodiment differs from the above embodiments in that the camping cart has a weather shelter detachably incorporated on top thereof. The weather shelter includes a canopy 400 and a skeleton system 300. The skeleton system 300 is configured to securely support the canopy 400, such that the canopy 400 can be deployed and cover the top of the camping cart. The skeleton system 300 includes a pole component 330, a truss component 320, and a plurality of support columns 310 arranged in a vertical direction, the pole component 330, the truss component 320, and the plurality of support columns 310 being arranged in sequence from top to bottom. The end corner member 7 at the top end corner of the camping cart is provided with a hole suitable for insertion of the support column 310, the hole being provided with a locking structure such as a threaded portion or a groove portion to lock the support column 310. The pole component 330 is attached to the truss component 320 to support the canopy 400 in a deployed state, enabling the canopy 400 to protect the camping device from sunlight and rain, thereby reducing damage to the camping device from sunlight exposure and rain. Referring to FIGS. 24 and 25, the plurality of support columns 310 are spaced apart from each other, and the truss component 320 is provided between the plurality of support columns 310. The truss component 320 includes connecting seats 322 attached to the top of the support columns 310, and a connecting rod 321 adapted to connect two of the connecting seats 322. With this structural design, not only the plurality of support columns 310 can be connected together, but also the plurality of support columns 310 are spaced apart from each other to form a stable frame support structure, to securely support the pole component 330. The pole component 330 includes a plurality of poles attached to the connecting seats 322, the plurality of poles crossing each other to form a support platform, which can support the canopy 400 to deploy and remain deployed, facilitating the protection for the camping device.

As shown in FIG. 25, there are four support columns 310, which are respectively provided at four end corners on the top of the camping cart. The truss component 320 includes two connecting rods 321 that cross each other, each of the connecting rods 321 being connected between corresponding two of the connecting seats 322 arranged opposite each other. Further, the truss component 320 also includes a crossing member 323, the crossing member 323 being arranged at the position in which the two connecting rods 321 cross each other, to be suitable for fixing the two connecting rods 321. Preferably, in this embodiment, there are four connecting rods 321 which are connected between the connecting seats 322 and the crossing member 323. Correspondingly, the crossing member 323 has four holes in which ends of the connecting rods 321 can be accommodated. The four connecting rods 321 are connected together through the crossing member 323 to form an X-shaped truss component 320. With the truss component 320 having the above structural design, the plurality of support columns 310 can be securely connected together to form a stable column support frame.

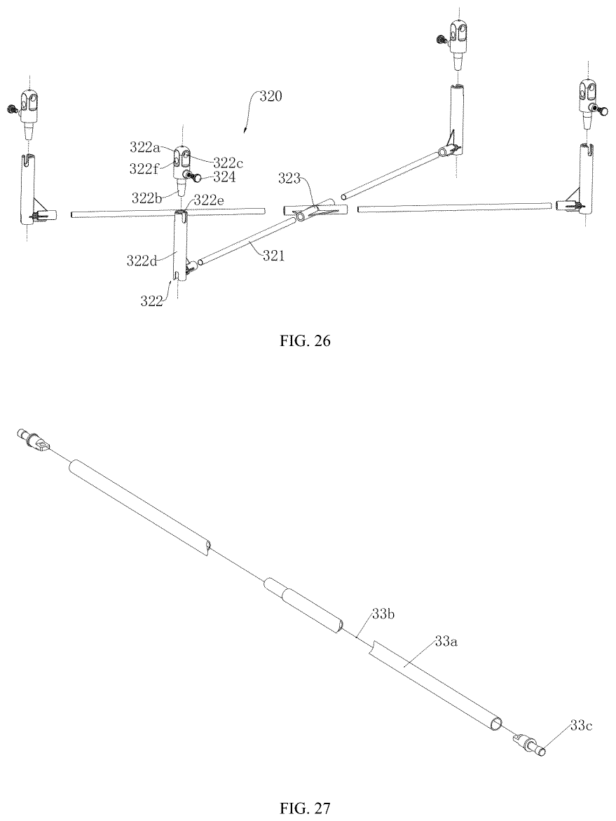

In addition, for the convenience of users in disassembling, assembling, and storing the skeleton system 300, various members are connected to each other in a detachable manner. The connecting rod 321 is detachably attached to the connecting seat 322, and the connecting seat 322 is detachably attached to the top of the support column 310. The connecting seat 322 includes an upper seat body 322a and a lower seat body 322d that can be separated from each other. The pole is detachably attached to the upper seat body 322a, and the connecting rod 321 and the support column 310 are detachably attached to the lower seat body 322d. Further, to facilitate the assembly between the upper seat body 322a and the lower seat body 322d, the upper seat body 322a has a fitting portion 322b extending downward, as shown in FIG. 26. The lower seat body 322d has a fitting groove 322e adapted to the fitting portion 322b, enabling more precise and faster assembly of the upper seat body and the lower seat body. Further, the lower seat body 322d is provided with a locking member for retaining the fitting portion 322b in the fitting groove 322e, which can prevent the upper seat body 322a from detaching from the lower seat body 322d during use. The locking member is a locking bolt 324 that extends in a radial direction of the lower seat body 322d and penetrates into the fitting groove 322e. The lower seat body 322d has a locking nut adapted to the locking bolt 324. The upper seat body 322a and the lower seat body 322d can be fastened together by the locking nut, further improving the stability of the truss component 320 and thus ensuring the stability of the skeleton system 300.

Further, as shown in FIGS. 25 and 26, the pole component 330 includes an upper pole 331 and a lower pole 332 arranged to cross each other. Correspondingly, the connecting seat 322 has an upper hole 322c for the upper pole 331 to pass through and a lower hole 322f for the lower pole 332 to pass through. The upper hole 322c and the lower hole 322f are arranged at an interval in an up-and-down direction, such that the upper pole 331 and the lower pole 332 can be staggered in the up-and-down direction, which does not affect the mounting of the upper pole 331 and the lower pole 332. In this embodiment, the upper hole 322c and the lower hole 322f are opened in a front-and-back direction and a left-and-right direction perpendicular to each other, respectively, and the number of the upper pole 331 and the number of the lower pole 332 are both set to two, such that the two upper poles 331 and the two lower poles 332 can be constructed as a “tic-tac-toe” structure. With the “tic-tac-toe” structure of the pole component 330, the canopy 400 can be supported in a deployed state, thereby protecting the camping device such as the camping cart and the items from the sunshine and rain, and reducing the damage to the camping device from the sunlight exposure and rain.

Referring to FIG. 27, the upper pole 331 includes a plurality of pole bodies 33a connected in sequence. Each pole body 33a has a hole at one end and a post at the other end. During assembly, the post of one of two adjacent pole bodies 33a is inserted into the hole of the other pole body 33a, and the plurality of pole bodies 33a are sequentially connected together to complete the assembly of the upper pole 331. Each of the pole bodies 33a located at both ends has an attaching portion 33c at an outer end thereof for attaching the canopy 400. Preferably, to facilitate better storage and assembly of the pole body 33a, a connecting rope 33b is further included. The pole body 33a has a perforation for the connecting rope 33b to pass through, and the connecting rope 33b can sequentially connect the plurality of pole bodies 33a together. In this way, during assembly, users can sequentially connect the plurality of pole bodies 33a together along an extension direction of the connecting rope 33b, such that there is no need to look around for the pole bodies 33a, which reduces the time required to look for the pole bodies 33a and improves the assembly efficiency. Moreover, after disassembling the upper pole 331, the plurality of pole bodies 33a can be kept connected together, such that the disassembled pole bodies 33a may not be scattered all over the place, making it convenient for users to store and organize. To reduce the costs, the lower pole 332 has the same structure as that of the upper pole 331, and also includes a plurality of pole bodies 33a connected in sequence.

In addition, the upper or lower pole also has attaching portions 33c on both ends thereof for attaching the canopy 400, which facilitates the assembly of the canopy 400. Correspondingly, the canopy 400 has a sleeve member adapted to the attaching portion 33c. During mounting, the sleeve member can be fitted onto the attaching portion 33c to attach the canopy 400 to the pole. To better support and fix the canopy 400, touch fasteners are arranged at intervals inside the canopy 400 in the direction of the pole, making it convenient for users to fix and mount the canopy 400.

To further enhance the stability of the skeleton system 300 to support the canopy 400 with a larger spread area, the truss component 320 is disposed at an upper end of the support columns 310 and close to the pole component 330, which can share the gravity force exerted by the canopy 400 on the pole component 330, thereby supporting the canopy 400 with a larger spread area.

As shown in FIG. 25, the support column 310 includes a plurality of column bodies sequentially connected in the vertical direction. The column body has an embedded hole on one end and an embedded portion on the other end. The embedded portion of one of two adjacent column bodies can be inserted into the embedded hole of the other column body, and the plurality of column bodies are sequentially connected together in the vertical direction to form the support column 310. Preferably, to ensure a stable connection between two adjacent column bodies, an elastic snap pin is provided inside the embedded portion. The elastic snap pin is an elastic piece fastened to an interior of the embedded portion, and the elastic piece has a pin head extending in a radial direction of the column body. Each of the embedded portion and the embedded hole is provided with a positioning hole on a side wall thereof for the pin head to pass through, and two adjacent column bodies can be securely connected together by providing the elastic snap pin.

As shown in FIG. 24, the skeleton system 300 of the weather shelter in the present application uses four support columns 310 for support, which is more stable with better anti-tipping performance compared to the use of a single support column for support in the related art. Meanwhile, the skeleton system 300 can support a larger area of pole component 330, the pole component 330 including the upper pole 331 and the lower pole 332 arranged at an interval in the up-and-down direction, which are not affected by each other during mounting. The length of the upper pole 331 and the lower pole 332 is larger than that of the existing umbrella-shaped skeleton in an unfolded state, so as to support a larger area of canopy 400. Preferably, the deployed area of the canopy 400 is 10 m² or more, for example, 12 m². The present application can provide a larger area of weather shelter protection area, which can prevent the camping device from being exposed to sunlight or soaked by rainwater. Meanwhile, the area of the canopy 400 can be reasonably designed and selected according to different sizes of camping carts to meet the use requirements when camping and increase the applicability of the weather shelter. Further, windproof ropes (not shown) are connected around the canopy 400 to fix the canopy 400, further improving the stability of the canopy 400.

The pole structure in this embodiment enables modularized design of the canopy 400, which means that manufacturers can design poles with corresponding lengths according to the size of the canopy 400 without adjusting shapes and sizes of other structures, which facilitates manufacturers to quickly and cost effectively launch multiple canopy products with different areas to meet the needs of different consumers.

### Embodiment IV

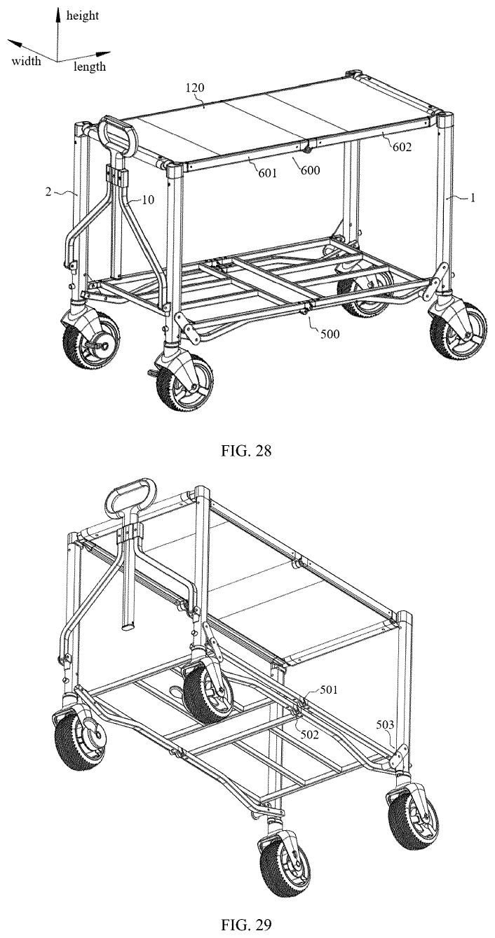

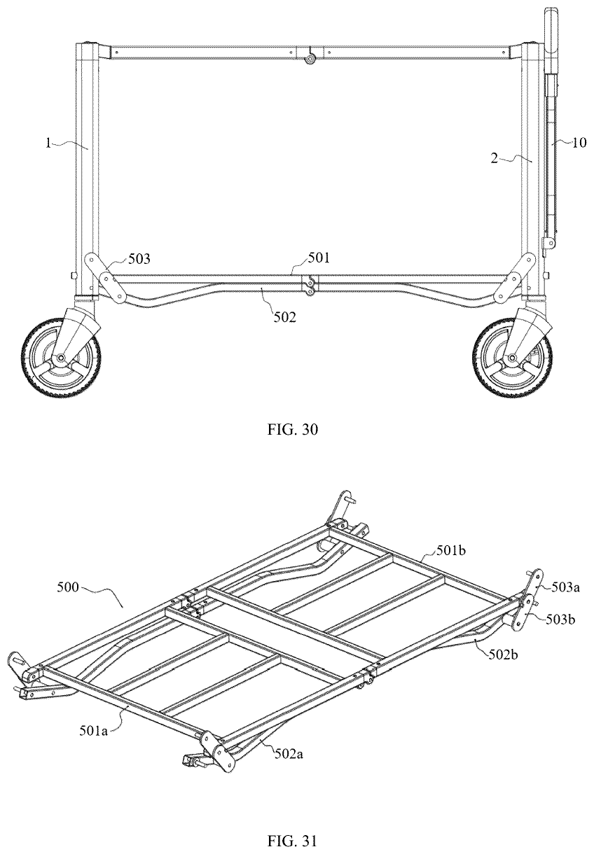

Referring to FIG. 28 to FIG. 36, the present embodiment provides a foldable camping cart including a first frame 1 and a second frame 2, the first frame 1 and the second frame 2 being folded and unfolded by means of a folding mechanism 500, the folding mechanism 500 being configured at the bottom of the camping cart to be adapted for load-bearing. When in use, the folding mechanism 500 can be folded up and down in a height direction of the camping cart, such that the first frame 1 and the second frame 2 move away from or close to each other to complete unfolding and folding of the camping cart.

In this embodiment, the folding mechanism 500 includes an upper folding member 501, a lower folding member 502, and a linkage component 503. The upper folding member 501 is operable to be folded upwards. The lower folding member 502 is foldable upwards along with the upper folding member 501 under the action of the linkage component 503, and is configured to support the upper folding member 501 in a preset position in an unfolded state. Meanwhile, the linkage component 503 is configured to connect the upper folding member 501 and the lower folding member 502 to the first frame 1 and to hold the upper folding member 501 in the preset position in the unfolded state. It should be noted that the preset position is a position where the folding mechanism 500 is folded downwards and is in a horizontal state, that is, the camping cart remains in the unfolded state in the preset position for use by users. In this embodiment, the linkage component 503 includes a first connecting link 503a and a second connecting link 503b that are pivotally connected to each other. The first connecting link 503a is pivotally connected to the first frame 1, the upper folding member 501 is pivotally connected to the first connecting link 503a, and the lower folding member 502 is pivotally connected to the second connecting link 503b. Moreover, when the upper folding member 501 is folded upwards, the upper folding member 501 can drive, through the linkage component 503, the lower folding member 502 to fold upwards along with the upper folding member 501, which improves the convenience of folding of the camping cart.

Further, to enable the upper folding member 501, when folded, to better drive the linkage component 503 and the lower folding member 502 to fold, the first connecting link 503a and the second connecting link 503b are connected to each other by a pivot shaft 503e. The upper folding member 501 is provided with a pivot hole connected with the pivot shaft 503e. Therefore, when the upper folding member 501 is pulled by a user to fold upwards, the first connecting link 503a and the second connecting link 503b can be driven to rotate around the pivot shaft 503e, so as to drive the lower folding member 502 to fold upwards along with the upper folding member 501, such that the upper folding member 501 and the lower folding member 502 can be synchronously folded upwards and downwards, enabling a more labor-saving and convenient folding of the whole camping cart. Moreover, the structure in which the upper folding member 501 and the lower folding member 502 are stacked can improve the load-bearing capacity of the folding mechanism 500 and also improve the stability of the camping cart.

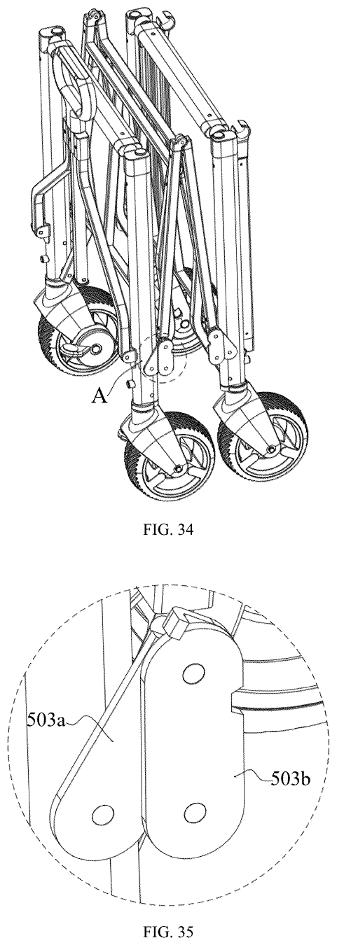

To improve the stability of the folding mechanism 500 when unfolded in the preset position, a catch portion 503c is provided between the first connecting link 503a and the second connecting link 503b, as shown in FIG. 33. The catch portion 503c is configured to limit the rotation of the first connecting link 503a and the second connecting link 503b when the upper folding member 501 is in the preset position. In this embodiment, the catch portion 503c is provided on the first connecting link 503a. For example, the catch portion 503c is integrally formed on the first connecting link 503a and has a protrusion extending towards the second connecting link 503b. When the folding mechanism 500 is in the unfolded state, the first connecting link 503a and the second connecting link 503b are rotated to be in the same straight line, and the protrusion of the catch portion 503c can be pressed against an upper end surface of the second connecting link 503b, thereby preventing the linkage component 503 from further rotating downwards. Preferably, the second connecting link 503b is provided with a catch groove 503d adapted to the catch portion 503c, where the catch groove 503d can receive the catch portion 503c, such that the first connecting link 503a and the second connecting link 503b can be caught together, thereby ensuring the stability of the folding mechanism 500 when unfolded.

In this embodiment, there are four linkage components 503 provided at four corners of the upper folding member 501, respectively. With the four linkage components 503, opposite ends of the folding mechanism 500 can be connected to the first frame 1 and the second frame 2, respectively, thereby improving the overall stability of the camping cart.

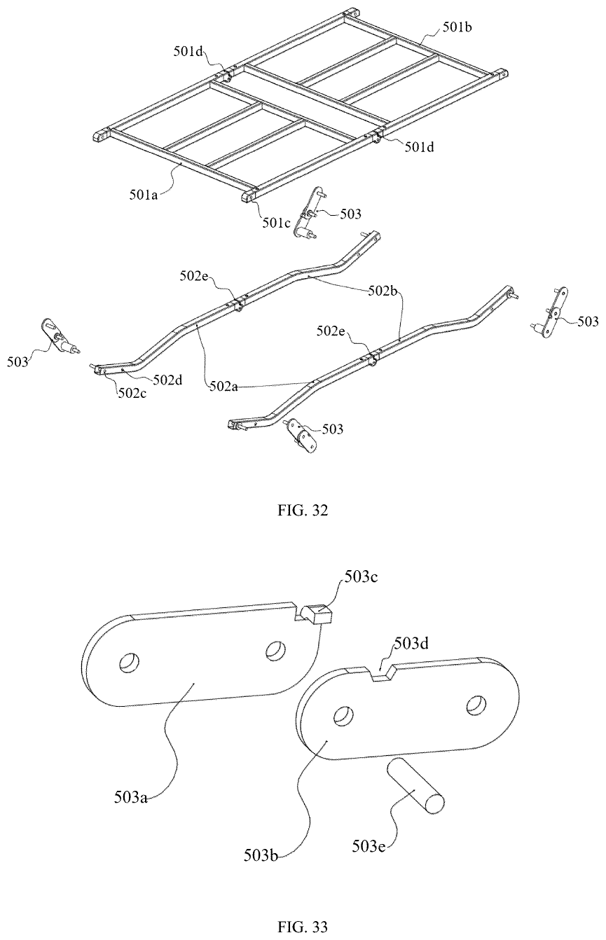

The upper folding member 501 includes a first hinge plate 501a and a second hinge plate 501b which are pivotally connected to each other, where an end of the first hinge plate 501a away from the second hinge plate 501b is connected to the first frame 1 by means of the linkage component 503, and an end of the second hinge plate 501b away from the first hinge plate 501a is connected to the second frame 2 by means of the linkage component 503. Further, the first hinge plate 501a and the second hinge plate 501b have first end surfaces 501d that can be pressed against each other in the preset position, where the first end surfaces 501d can prevent the upper folding member 501 from being further folded downwards in the preset position, enabling the first hinge plate 501a and the second hinge plate 501b to remain unfolded in the preset position so as to support items. As shown in FIG. 31 and FIG. 32, each of the first hinge plate 501a and the second hinge plate 501b includes a plurality of longitudinal bars extending in a length direction of the camping cart, and a first transverse bar (e.g., left transverse bar) and a second transverse bar (e.g., right transverse bar) extending in a width direction of the camping cart, with the plurality of longitudinal bars attached to the first transverse bar and the second transverse bar. For example, the plurality of longitudinal bars include two main bars, and two connecting bars provided between the first transverse bar and the second transverse bar, so as to form a frame structure, which can effectively support the items, and improve the load-bearing effect of the camping cart.

The lower folding member 502 includes a third hinge plate 502a and a fourth hinge plate 502b which are pivotally connected to each other, where the third hinge plate 502a is pivotally connected to the first frame 1, and the fourth hinge plate 502b is pivotally connected to the second frame 2, such that the third hinge plate 502a can be folded upwards around the first frame 1, and the fourth hinge plate 502b can be folded upwards around the second frame 2. Further, each of the third hinge plate 502a and the fourth hinge plate 502b includes at least one pole extending in the length direction of the camping cart, where the third hinge plate 502a and the fourth hinge plate 502b have second end surfaces 502e that can be pressed against each other, and when the lower folding member 502 is unfolded, the second end surfaces 502e of the third hinge plate 502a and the fourth hinge plate 502b are pressed against each other, so as to prevent the lower folding member 502 from continuing to be folded downwards in the preset position, enabling better support for the upper folding member 501. In this embodiment, as shown in FIG. 32, the third hinge plate 502a has two first poles (e.g., left poles) symmetrically disposed in the width direction of the camping cart, and the fourth hinge plate 502b has two second poles (e.g., right poles) symmetrically disposed in the width direction of the camping cart. When the camping cart is unfolded, the two left poles can respectively support two bottom sides of the first hinge plate 501a, and the two right poles are configured to respectively support two bottom sides of the second hinge plate 501b, such that the upper folding member 501 is in a horizontally unfolded state in the preset position, thereby better supporting and loading the items.

Preferably, a width of the lower folding member 502 is less than that of the upper folding member 501, such that a position where the third hinge plate 502a is pivotally connected to the fourth hinge plate 502b can avoid a position where the first hinge plate 501b is pivotally connected to the second hinge plate 501b, which facilitates the mounting and folding of the folding mechanism 500.

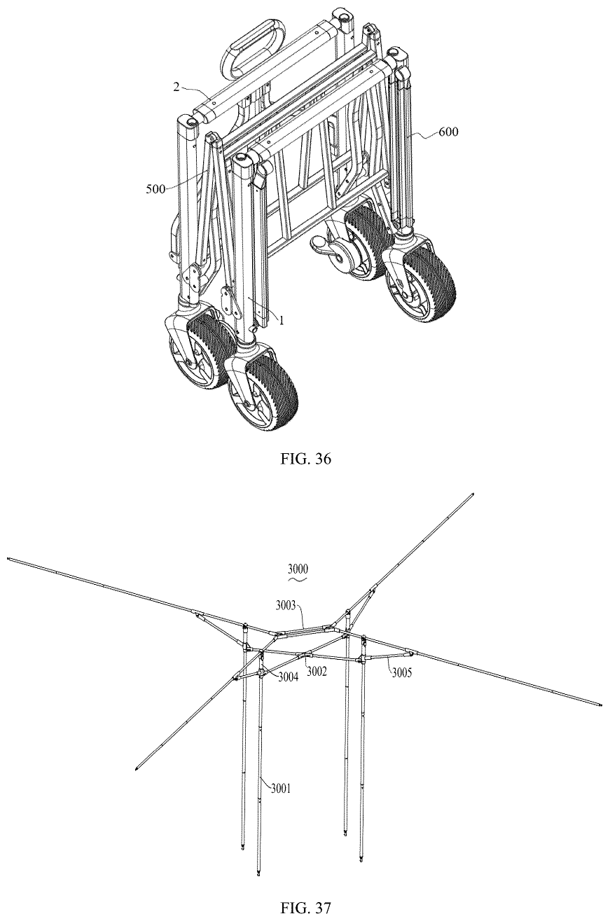

In this embodiment, the first frame 1 and the second frame 2 are provided, on tops thereof, with a support member 600 adapted to support a functional unit 120, where a first end of the support member 600 is pivotally connected to the first frame 1, and a second end of the support member 600 is detachably connected to the second frame 2. When the camping cart is folded, the second end of the support member 600 is separated from the second frame 2, and the first end of the support member 600 is rotated around the first frame 1 to a storage position as shown in FIG. 36, which facilitates the folding of the camping cart. Further, a pair of support members 600 are provided, and the functional unit 120 is at least one of a table board, a cooking appliance, or a storage container. When in use, it is only necessary to place the corresponding functional unit 120 directly on the pair of support members 600 and across the camping cart in the width direction of the camping cart, so as to accommodate a larger number of functional units 120, which is convenient for assembly. For example, the functional unit 120 is an IGT unit which has a size of about 250 mm×360 mm, and a distance between the pair of support members 600 in the width direction is 300 mm to 500 mm to be suitable for placing the IGT unit.

As shown in FIGS. 28 and 34 to 36, in this embodiment, the support member 600 includes a first rod unit 601 and a second rod unit 602 that are pivotally connected to each other. When the camping cart is folded, the first rod unit 601 and the second rod unit 602 can be folded accordingly, so as to be stored in the storage position, which improves the convenience of use.

To facilitate the user to pull the camping cart to move, wheels are provided at bottoms of the first frame 1 and the second frame 2, and the second frame 2 is further provided with a handle 10 pivotally connected thereto as shown in FIG. 28. When pulling the camping cart to move, the user can flexibly adjust a tilt angle of the handle 10. Moreover, the handle 10 has a telescopic structure, which enables the handle 10 to be extended when the user pulls the camping cart, and to be contracted together and attached to a side wall of the second frame 2 when the camping cart is not in use, making it simple and convenient to use.

To better illustrate the folding and unfolding actions of the folding mechanism 500, the movement of one of the linkage components 503 will be described herein.

The third hinge plate 502a has a first pivot portion 502c and a second pivot portion 502d at an end thereof, where the first pivot portion 502c is connected to the first frame 1, and the second pivot portion 502d is pivotally connected to the second connecting link 503b. A pivot hole 501c at an end of the first hinge plate 501a is pivotally connected to the pivot shaft 503e between the first connecting link 503a and the second connecting link 503b. A column of the first frame 1, the first connecting link 503a, the second connecting link 503b, and the third hinge plate 502a form a four-link mechanism. When the upper folding member 501 and the lower folding member 502 are folded downwards such that the camping cart is in the unfolded state, the upper folding member 501 and the lower folding member 502 are both in a horizontal state, and the first connecting link 503a and the second connecting link 503b are in the same straight line, at which time the four-link mechanism is in a dead point position, such that both the upper folding member 501 and the lower folding member 502 can be kept in the unfolded state. Moreover, the first connecting link 503a and the second connecting link 503b are further kept in a straight line due to the arrangement of the catch portion 503c, and when the lower folding member 502 is directly pushed in this state, the lower folding member 502 is kept in a locked state and cannot be rotated, such that the stability of the camping cart is ensured, and the camping cart cannot be loosened during dragging and moving of the camping cart. When the camping cart needs to be folded, the first hinge plate 501a is driven to be folded upwards, which drives the pivot shaft 503e to move upwards, such that the four-link mechanism is released from the dead point position and moves correspondingly, which in turn drives the lower folding member 502 to be folded upwards synchronously along with the upper folding member 501. The overall folding action is more labor-saving and convenient, and is more stable with a good use effect.

### Embodiment V

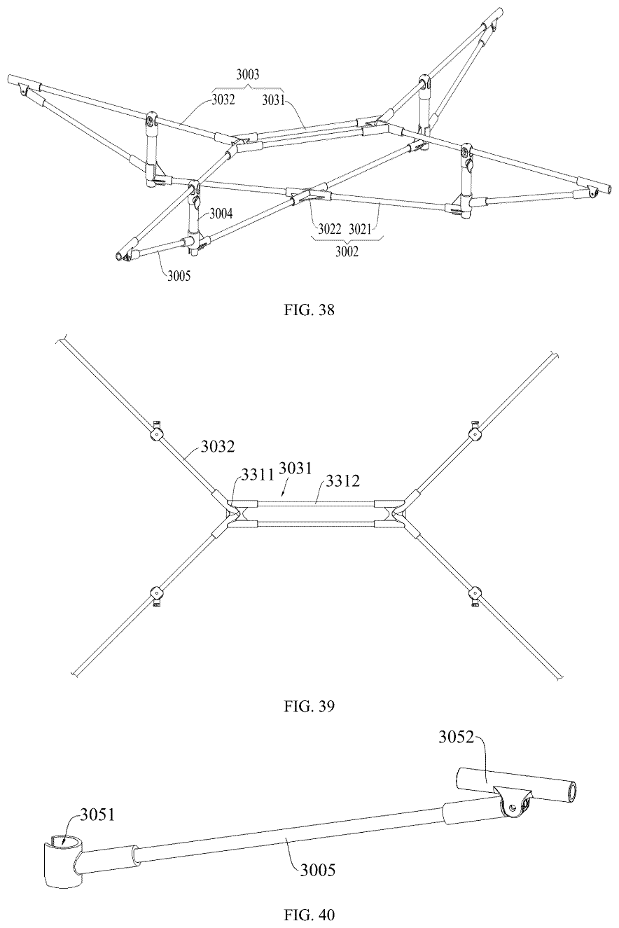

Referring to FIG. 37 to FIG. 42, this embodiment provides a skeleton 3000 for supporting a canopy 400. The skeleton 3000 includes: a plurality of upright rods 3001 arranged in a vertical direction; an auxiliary skeleton 3002 configured to form a connection among the plurality of upright rods 3001 and to separate the plurality of upright rods 3001 from each other; and a main skeleton 3003 coupled to the upright rods 3001 and configured to support the canopy 400 in a deployed state, where the main skeleton 3003 includes a plurality of cross rods 3032 and a connecting frame 3031 for connecting the plurality of cross rods 3032, each of the cross rods 3032 having one end portion coupled to the connecting frame 3031, and the other end portion extending outwards from the connecting frame 3031 to support the canopy 400.

With the above technical solution, the main skeleton 3003 and the auxiliary skeleton 3002 are supported by the upright rods 3001, so as to ensure the support height of the skeleton 3000, such that the canopy 400 can be better used for shielding users from the sun and rain when in use. There are four upright rods 3001, and the auxiliary skeleton 3002 is used for separating four mounting seats 3004 from each other to form a rectangular frame, and is also used for supporting the main skeleton 3003, such that the whole skeleton 3000 is more stable, thereby ensuring the stability of the support of the canopy 400. Further, the main skeleton 3003 includes the connecting frame 3031 and the plurality of cross rods 3032 attached to the connecting frame 3031, where the cross rods 3032 extend outwards to expand the shading area of the canopy 400, so as to provide a larger shading area. Preferably, the cross rods 3032 are detachably attached to the connecting frame 3031 to facilitate assembly and disassembly.

In addition, the canopy 400, when supported, is subjected to more loads in the middle thereof, and thus the middle of the canopy 400 is more prone to collapse, which affects the support height for the canopy 400. To better support the canopy 400, in this embodiment, the auxiliary skeleton 3002 is used to connect the four upright rods 3001 at intervals with each other, which can effectively support the middle of the canopy 400 and improve the support strength for the canopy 400. Moreover, the four upright rods 3001 are concentrated together, which is also convenient for personnel to directly carry the skeleton 3000. Also, the four cross rods 3032 extend outwards to better deploy the canopy 400, which reduces the use of windproof ropes, that is, there is no need to fix the periphery of the canopy 400 by use of the windproof ropes. This addresses the problems in the related art that the installation is cumbersome, the support area for the canopy is reduced, and also the carrying of the canopy is affected due to the fact that the canopy needs to be fixed by means of the windproof ropes. In addition, the four upright rods 3001 in this embodiment are close to each other with a small distance therebetween, and thus are suitable for being mounted on an outdoor mobile device such as a camping cart 1000, such that the camping cart 1000 can be conveniently pulled to move the canopy, and people can be better shielded from the sun.

Further, the connecting frame 3031 includes two connecting seats 3311, which are provided with insertion portions for the cross rods 3032 to be inserted and fixed. The connecting frame 3031 further includes at least one main connecting rod 3312 for connecting the two connecting seats 3311, so as to improve the stability of the connecting frame 3031. Preferably, there are two main connecting rods 3312 arranged in parallel with each other, and the two connecting seats 3311 are connected by the two main connecting rods 3312 to form a rectangular frame, thereby improving the stability of the connecting frame 3031. Referring to FIG. 39, the connecting seat 3311 includes a horizontal connecting post and a corner connecting post, where the horizontal connecting post has holes for the two main connecting rods 3312 to be inserted, and the insertion portions are formed as holes integrally formed in the corner connecting post. Preferably, the corner connecting post is a right-angle connecting post, and there are four cross rods 3032 which are divided into two groups, where two cross rods 3032 in each group are respectively inserted into two insertion portions of the corresponding right-angle connecting post, and extend along two right-angle sides of the right-angle connecting post. The four cross rods 3032 are formed in a symmetrical structure similar to symbols “>” and “<” when viewed from top to bottom, which can effectively support the unfolding of the canopy 400.

Further, each of the upright rods 3001 has the mounting seat 3004 coupled on the top thereof, and the main skeleton 3003 and the auxiliary skeleton 3002 are both assembled on the mounting seat 3004. A slanting pole 3005 is connected between each of the mounting seats 3004 and a respective cross rod 3032, and extends at an angle from the mounting seat 3004 towards the cross rod 3032 for further supporting the cross rod 3032, so as to improve the support strength of the cross rod 3032 for the canopy 400. The slanting pole 3005 is provided, at one end, with a catch groove 3051 adapted to be caught onto the mounting seat 3004, and is provided, at the other end, with a support sleeve 3052 to be disposed around the cross rod 3032. The support sleeve 3052 is hingedly connected to the slanting pole 3005, and the support sleeve 3052 has a through hole through which the cross rod 3032 passes, such that the cross rod 3032 passes through the support sleeve 3052 via the through hole and is connected to the slanting pole 3005.

Referring to FIG. 42, in this embodiment, each of the mounting seats 3004 includes an upper seat body 3041 and a lower seat body 3042 separable from each other. The cross rods 3032 are attached to the upper seat bodies 3041 of the mounting seats 3004, respectively, the upright rods 3001 are attached to the lower seat bodies 3042 of the mounting seats 3004, respectively, and the auxiliary skeleton 3002 is attached to the lower seat bodies 3042 of the mounting seats 3004. Further, the upper seat body 3041 has a fitting portion 3412 extending downwards, and the lower seat body 3042 has a fitting groove 3421 adapted to the fitting portion 3412. The upper seat body 3041 is provided with a locking member 3043 for holding the fitting portion 3412 in the fitting groove 3421. The locking member 3043 is a locking bolt extending in a radial direction of the upper seat body 3041 and penetrating into the fitting groove 3421, and the upper seat body 3041 has a locking nut adapted to the locking bolt. The connection between the upper seat body 3041 and the lower seat body 3042 can be tightened by locking and fixing the upper seat body 3041 and the lower seat body 3042 with the locking nut, thereby improving the support strength of the mounting seat 3004 when in use. In this embodiment, a lower end of the lower seat body 3042 has a protruding portion extending in a radial direction thereof, so as to be suitable for connection with the auxiliary skeleton 3002. The lower seat body 3042 is of a hollow structure in the middle thereof, and the top of the upright rod 3001 can penetrate into the middle of the lower seat body 3042, and the locking nut can pass through the fitting groove 3421 to be pressed against the upright rod 3001, so as to fix the mounting seat 3004 to the upright rod 3001. This improves the strength of the connection between the upright rod 3001 and the mounting seat 3004. The upper seat body 3041 has a through hole 3411 extending in a radial direction thereof, where the through hole 3411 is configured for the cross rod 3032 to pass through.

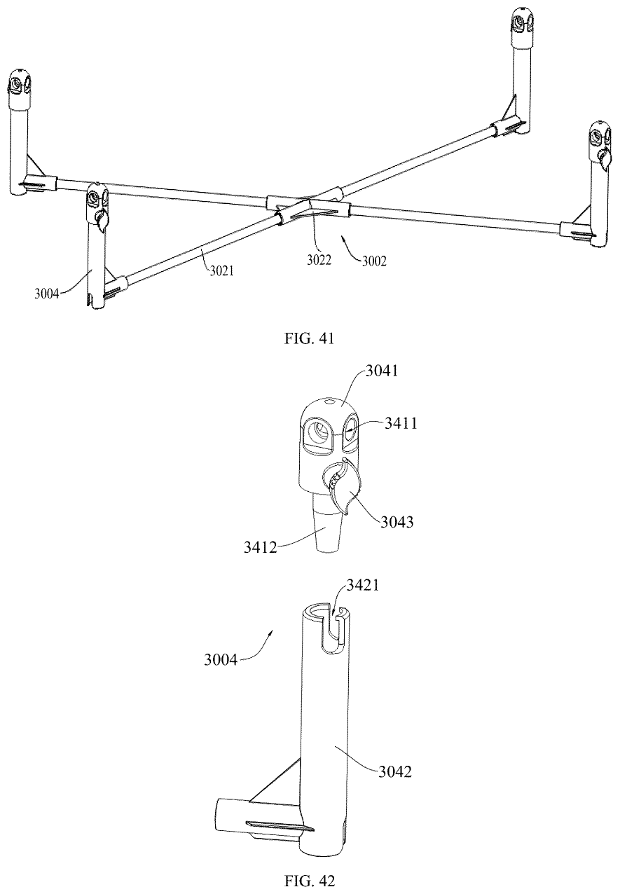

Referring to FIG. 41, the auxiliary skeleton 3002 includes at least two auxiliary connecting rods 3021 forming a connection among a plurality of mounting seats 3004. Further, the at least two auxiliary connecting rods 3021 are arranged to cross each other to form a connection between two of the mounting seats 3004 opposite to each other, so as to connect the plurality of upright rods 3001 to each other. In addition, the auxiliary skeleton 3002 further includes a crossing member 3022 configured to connect the auxiliary connecting rods 3021 in a cross shape. As shown in FIG. 41, two auxiliary connecting rods 3021 form an X-shaped frame, with which the connection among the four upright rods 3001 is more stable. Moreover, the connecting frame 3031 is disposed above the X-shaped frame, and is combined with the X-shaped frame to further improve the stability of an upper end of the skeleton 3000, thereby better supporting the canopy 400. Preferably, one end of the auxiliary connecting rod 3021 is detachably connected to the lower seat body 3042, and the other end of the auxiliary connecting rod 3021 is detachably connected to the crossing member 3022 for ease of assembly. For example, there are four auxiliary connecting rods 3021 connected between the mounting seats 3004 and the crossing member 3022. Accordingly, the crossing member 3022 has four holes capable of accommodating ends of the auxiliary connecting rods 3021, such that the four auxiliary connecting rods 3021 are connected together through the crossing member 3022.

In this embodiment, each of the cross rods 3032 is formed by sequentially connecting a plurality of short poles, each of which has an insertion portion at one end and a slot at the other end. The insertion portion of one of adjacent two of the short poles can be inserted into the slot of the other short pole, so as to assemble the plurality of short poles together sequentially to form the cross rod 3032, which enables the whole skeleton 3000 easy to disassemble and assemble, and convenient to store and carry. Further, each cross rod 3032 is further provided with a connecting portion at an end thereof for connecting windproof ropes, so as to connect and fix end portions of the four cross rods 3032 through the windproof ropes, and thus fix the canopy 400 when the wind is strong, which improves the stability of the construction of the canopy 400.

It should also be noted that, in this embodiment, each of the upright rods 3001 is formed by sequentially connecting a plurality of short rods, and adjacent short rods are connected to each other by means of insertion, enabling the assembly simpler and more convenient. Further, the upright rods 3001, the main skeleton 3003, and the auxiliary skeleton 3002 can be assembled and separated from each other, which is convenient to construct, carry and transfer. In addition, to ensure the strength and lightweight of the skeleton 3000, the skeleton 3000 may be made of lightweight materials, such as aluminum alloy, carbon fiber, and composite materials.

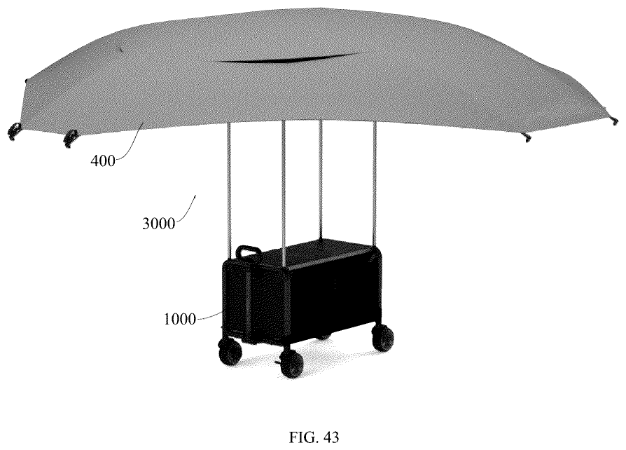

Referring to FIG. 43, this embodiment further provides a weather shelter that is convenient to construct, including a canopy 400 and a skeleton, where the skeleton adopts the above skeleton 3000, which can effectively deploy the canopy 400 so as to provide weather shielding for users. In the present embodiment, by adopting the above skeleton 3000, a ratio of a deployed area S1 of the canopy 400 to an area S2 of a horizontal frame defined between the four upright rods 3001 is 4 to 20, so as to support a larger area of the canopy 400, and thus provide better weather shielding for the users. Further, the ratio of S1 to S2 is 6 to 10, in which ratio range the stability is better. The specific ratio can be flexibly designed according to the use requirements, and will not be described in detail herein.

Further, when in use, the weather shelter can be directly fixed on the ground, or can be used in combination with the camping cart 1000. Therefore, the users can directly construct the weather shelter on the camping cart 1000 when camping outdoors, thereby shielding items placed in the camping cart 1000 from the sun, and avoiding deterioration of the items placed in the camping cart 1000 due to exposure to the sun.

As shown in FIG. 43, this embodiment further provides an outdoor camping device, which includes a camping cart 1000 and a weather shelter, the weather shelter being detachably assembled on the camping cart 1000 and including a canopy 400 and a skeleton, where the skeleton is the above skeleton 3000. With the above structure, the users, when camping outdoors, can directly construct the weather shelter on the camping cart 1000, so as to shield items placed in the camping cart 1000 from the sun and avoid deterioration of the items placed in the camping cart 1000 due to exposure to the sun. Further, to facilitate the construction of the weather shelter and the camping cart 1000, the camping cart 1000 only needs to be provided with holes at end corners thereof for the upright rods 3001 to be inserted. The size of the skeleton 3000 can be adapted to the size of the camping cart 1000, to enable the connection between the skeleton 3000 and the camping cart 1000 more compatible. Meanwhile, the plurality of upright rods 3001 are disposed at the end corners of the camping cart 1000, which does not affect the placement of the functional units such as table boards on top of the camping cart 1000, and is more convenient to use.

The foregoing only illustrates specific implementations of the present application, but the scope of protection of the present application is not limited thereto. Any changes or substitutions that can be readily thought of by those skilled in the art within the technical scope disclosed herein shall be covered by the scope of protection of the present application. Therefore, the scope of protection of the present application shall be based on the scope of protection of the claims.

1. A foldable camping cart, comprising a first frame and a second frame, the first frame and the second frame being folded and unfolded by means of a folding mechanism, the folding mechanism being configured at a bottom of the camping cart to be adapted for load-bearing, wherein the folding mechanism comprises:
an upper folding member, which is operable to be folded upwards;
a lower folding member, which is foldable upwards and is configured to support the upper folding member in a preset position in an unfolded state; and
a linkage component configured to connect the upper folding member and the lower folding member to the first frame and to hold the upper folding member in the preset position in the unfolded state,
wherein the linkage component comprises a first connecting link and a second connecting link pivotally connected to each other, the first connecting link is pivotally connected to the first frame, the upper folding member is pivotally connected to the first connecting link, and the lower folding member is pivotally connected to the second connecting link; and
when the upper folding member is folded upwards, the upper folding member can drive, through the linkage component, the lower folding member to fold upwards along with the upper folding member.

2. The foldable camping cart according to claim 1, wherein the linkage component is adapted to connect the upper folding member and the lower folding member to the second frame.

3. The foldable camping cart according to claim 1, wherein the first connecting link and the second connecting link are connected to each other by a pivot shaft, and the upper folding member is pivotally connected to the pivot shaft.

4. The foldable camping cart according to claim 3, wherein the first connecting link is provided with a catch portion, and the second connecting link is provided with a catch groove adapted to the catch portion, so as to remain the first connecting link and the second connecting link in the unfolded state.

5. The foldable camping cart according to claim 1, wherein there are four linkage components, which are provided at four corners of the upper folding member, respectively.

6. The foldable camping cart according to claim 2, wherein the upper folding member comprises a first hinge plate and a second hinge plate pivotally connected to each other, the first hinge plate being connected to the first frame by means of the linkage component, and the second hinge plate being connected to the second frame by means of the linkage component.

7. The foldable camping cart according to claim 6, wherein each of the first hinge plate and the second hinge plate comprises a plurality of longitudinal bars extending in a length direction of the camping cart, and a first transverse bar and a second transverse bar extending in a width direction of the camping cart, the plurality of longitudinal bars being attached to the first transverse bar and the second transverse bar.

8. The foldable camping cart according to claim 2, wherein the lower folding member comprises a third hinge plate and a fourth hinge plate pivotally connected to each other, the third hinge plate being pivotally connected to the first frame, and the fourth hinge plate being pivotally connected to the second frame.

9. The foldable camping cart according to claim 8, wherein each of the third hinge plate and the fourth hinge plate comprises at least one pole extending in a length direction of the camping cart.

10. The foldable camping cart according to claim 1, wherein the first frame and the second frame are provided, on tops thereof, with a support member adapted to support a functional unit, a first end of the support member being pivotally connected to the first frame, and a second end of the support member being detachably connected to the second frame, wherein the support member comprises a first rod unit and a second rod unit pivotally connected to each other for storage of the support member.

11. An outdoor camping device, comprising the foldable camping cart according to claim 1.

12. The outdoor camping device according to claim 11, wherein the camping cart has a weather shelter detachably mounted on a top thereof, the weather shelter comprising a canopy and a skeleton for supporting the canopy, wherein the skeleton comprises:
a plurality of upright rods arranged in a vertical direction;
an auxiliary skeleton configured to form a connection among the plurality of upright rods and to separate the plurality of upright rods from each other; and
a main skeleton coupled to the upright rods and configured to support the canopy in a deployed state,
wherein the main skeleton comprises a plurality of cross rods and a connecting frame for connecting the plurality of cross rods, each of the cross rods having one end portion coupled to the connecting frame, and the other end portion extending outwards from the connecting frame to support the canopy.

13. The outdoor camping device according to claim 12, wherein the connecting frame comprises two connecting seats, which are provided with insertion portions for insertion and assembly of the cross rods.

14. The outdoor camping device according to claim 13, wherein the connecting frame further comprises two main connecting rods for connecting the two connecting seats, the two main connecting rods being parallel to each other.

15. The outdoor camping device according to claim 12, wherein mounting seats are coupled on tops of the upright rods, respectively, and the main skeleton and the auxiliary skeleton are both assembled to the mounting seats.

16. The outdoor camping device according to claim 15, wherein a slanting pole is connected between each of the mounting seats and a respective cross rod, and extends at an angle from the mounting seat towards the cross rod.

17. The outdoor camping device according to claim 15, wherein the auxiliary skeleton comprises at least two auxiliary connecting rods which form a connection among the mounting seats, the auxiliary connecting rods crossing each other to form a connection between two of the mounting seats opposite to each other.

18. The outdoor camping device according to claim 17, wherein the auxiliary skeleton further comprises a crossing member configured to connect the auxiliary connecting rods in a cross shape.

19. The outdoor camping device according to claim 15, wherein each of the mounting seats comprises an upper seat body and a lower seat body separable from each other, wherein the cross rods are coupled to the upper seat bodies of the mounting seats, respectively, the upright rods are coupled to the lower seat bodies of the mounting seats, respectively, and the auxiliary skeleton is coupled to the lower seat bodies of the mounting seats.

20. The outdoor camping device according to claim 19, wherein
the upper seat body is provided with a fitting portion which extends downwards, the lower seat body is provided with a fitting groove adapted to the fitting portion, and the upper seat body is provided with a locking member for holding the fitting portion in the fitting groove; and
the upper seat body is provided with a through hole extending in a radial direction thereof, the through hole being configured for the cross rod to pass through.
